(19) United States
(12) Patent Application Publication
(10) Pub. No.: US 2016/0246851 A1
(43) Pub. Date: Aug. 25, 2016

(54) DOCUMENT SEARCH APPARATUS AND DOCUMENT SEARCH METHOD

(71) Applicant: FUJITSU LIMITED, Kawasaki-shi (JP)

(72) Inventor: Shuya ABE, Kawasaki (JP)

(73) Assignee: FUJITSU LIMITED, Kawasaki-shi (JP)

(21) Appl. No.: 14/995,390

(22) Filed: Jan. 14, 2016

(30) Foreign Application Priority Data
Feb. 25, 2015 (JP) 2015-034975

(51) Int. Cl. G06F 17/30

(52) U.S. Cl. CPC G06F 17/30536; G06F 17/30477

(57) ABSTRACT

A document search apparatus receives a request (search request) from a user, and issues to a document set management system a search query that constructed in accordance with the limits on the use of a search service. A storage unit stores a plurality of search terms. A generation unit selects two or more of the search terms. The generation unit determines a combination of search terms to be selected such that the size of the search query is equal to or less than a first threshold, and such that an estimated value of the number of documents to be retrieved by the document set management system in response to the search query is equal to or less than a second threshold.

### CROSS-REFERENCE TO RELATED APPLICATION

This application is based upon and claims the benefit of priority of the prior Japanese Patent Application No. 2015-034975, filed on Feb. 25, 2015, the entire contents of which are incorporated herein by reference.

### FIELD

The embodiments discussed herein are related to a document search apparatus and a document search method.

### BACKGROUND

There are information processing systems that manage a large set of documents. For example, some of the systems providing so-called social networking services receive texts posted by a number of users via the Internet, and distribute each posted text to other users than the user who posted the text, based on the settings of each user. The systems that manage a large set of documents often provide a search service which receives a search query including a search term, retrieves documents containing the search term from the managed set of documents, and transmits the retrieved documents. For example, by using a search service provided by a system storing texts posted by a number of users, it is often possible to know the trend of public interest in a certain theme.

There has been proposed a statistical estimation apparatus that assists in filtering a set of search results by adding a search term. The proposed statistical estimation apparatus searches for elements that match a search term from a database, obtains a search result set, and extracts a part of the obtained search result set as a sample set. When an additional search term is specified, the statistical estimation apparatus searches for elements that match the additional search term from the sample set so as to obtain a sample subset. The statistical estimation apparatus calculates the appearance rate, by dividing the number of elements of the sample, subset by the number of elements of the entire, sample set. Then, the statistical estimation apparatus multiplies the number of elements of the original search result set by the appearance rate, and thereby estimates the number of elements to be obtained by performing a search in the database, again using the original search term and the additional search term.

There has also been proposed a search range, determination apparatus that changes a search condition such that the number of search results obtained from a target database, falls in the range specified by the user. The proposed search range determination apparatus transmits a sample search condition to the target database, in advance, and obtains the number of search results matching the sample search condition. Further, the search range determination apparatus searches a basic database smaller than the target database, and obtains the number of search results matching the sample search condition. Then, the search range determination apparatus calculates in advance the ratio of the number of search results of the target database to the number of search results of the, basic database. When a search condition is specified by the user, the search range determination apparatus searches the basic database before searching the target database, multiplies the number of search results of the basic database by the ratio calculated in advance, and thereby estimates the number of search results to obtained from the target database.

See, for example, Japanese Laid-open Patent Publications No. 11-85764 and No. 2000-99514.

The user of a system providing a search service often needs to collect a huge amount of documents relevant to a wide variety of search terms, by using the search service For example, as described above, the user often needs to collect texts related to various themes so as to analyze the trend of the public interest. In this case, the documents that the user needs to obtain may be documents containing at least one of a number of search terms. That is, the search condition may be one that includes many search terms combined with the OR operator Accordingly, if a search query including all the desired search terms is transmitted to the system so as to obtain all the documents containing at least one of the search terms in one batch, an excessive processing load is imposed on the system.

Thus, in some cases, in order not to impose an excessive processing load, restrictions are placed on the use, of the search service. In other cases, the user needs to voluntarily place restrictions on the use of the search service in response to a request from the system operator.

If there are restrictions on the use of the search service, the user might not be allowed to issue a “heavy” search query including many search terms combined with the OR operator. Thus, the user needs to issue a plurality of “light” search queries instead. However, the problem is how to create search queries that enable efficient retrieval of all the desired documents under system restrictions.

### SUMMARY

According to one aspect of the invention, there is provided a document search apparatus that includes: a memory configured to store a plurality of search terms specified by a request, the request requesting a search for a document containing at least one of the plurality of search terms by using a system that manages a document set; and a processor configured to perform a procedure, including: when selecting two or more search terms from the plurality of search terms and generating a search query that includes the selected two or more search terms and that is to be input to the system, determining a combination of search terms to be selected such that a size of the search query is equal to or less than a first threshold, and such that an estimated value of a number of documents to be retrieved by the system in response to the arch query is equal to or less than a second threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the configuration of a document search apparatus according to a first embodiment;

FIG. 2 illustrates an example of the configuration of a search system according to a second embodiment;

FIG. 3 illustrates an example of the hardware configuration of a search mediation server according to the second embodiment;

FIG. 4 illustrates an example of the functional configuration of the search mediation server according to the second embodiment;

FIG. 5 is a flowchart of a search mediation process according to the second embodiment;

FIGS. 6 and 7 are flowcharts of a query construction process according to the second embodiment;

FIG. 8 illustrates an example of a search term table according to the second embodiment;

FIG. 9 illustrates an example of a query candidate list according to the second embodiment;

FIG. 10 illustrates an example of a query candidate list according to the second embodiment;

FIG. 11 illustrates an example of a search term table according to the second embodiment;

FIG. 12 is a flowchart of a search service use process according to the second embodiment;

FIG. 13 is a flowchart of an estimation parameter update process according to the second embodiment;

FIG. 14 is a flowchart of a known ratio update process according to the second embodiment;

FIG. 15 illustrates an example of a ratio table according to the second embodiment;

FIG. 16 is a flowchart of a known co-occurrence ratio update process according to the second embodiment;

FIG. 17 illustrates an example of a co-occurrence ratio table according to the second embodiment;

FIG. 18 is a flowchart of a similarity parameter update process according to the second embodiment;

FIG. 19 illustrates an example of a similarity parameter table according to the second embodiment;

FIG. 20 is a flowchart of an estimated ratio update process according to the second embodiment;

FIG. 21 is a flowchart of a similarity calculation process according to the second embodiment;

FIG. 22 is a flowchart of an estimated co-occurrence ratio update process according to the second embodiment;

FIG. 23 illustrates an example of a relationship dictionary according to the second embodiment;

FIG. 24 illustrates an example of issuing a search query (in the case where document sets do not overlap) according to a reference embodiment;

FIG. 25 illustrates an example of issuing a search query (in the case where document sets do not overlap) according to the second embodiment;

FIG. 25 illustrates an example of issuing a search query the case where document sets overlap) according to the reference embodiment;

FIG. 27 illustrates an example of issuing a search query (in the case where document sets overlap) according to the second embodiment;

FIG. 28 illustrates an example of a user interface display before query execution according to the second embodiment;

FIG. 29 illustrates an example of a user interface display after query execution according to the second embodiment; and

FIG. 30 illustrates an example of a user interface display displaying a log according to the second embodiment.

### DESCRIPTION OF EMBODIMENTS

Several embodiments will be described below with reference to the accompanying drawings, wherein like reference numerals refer to like elements throughout.

### (a) First Embodiment

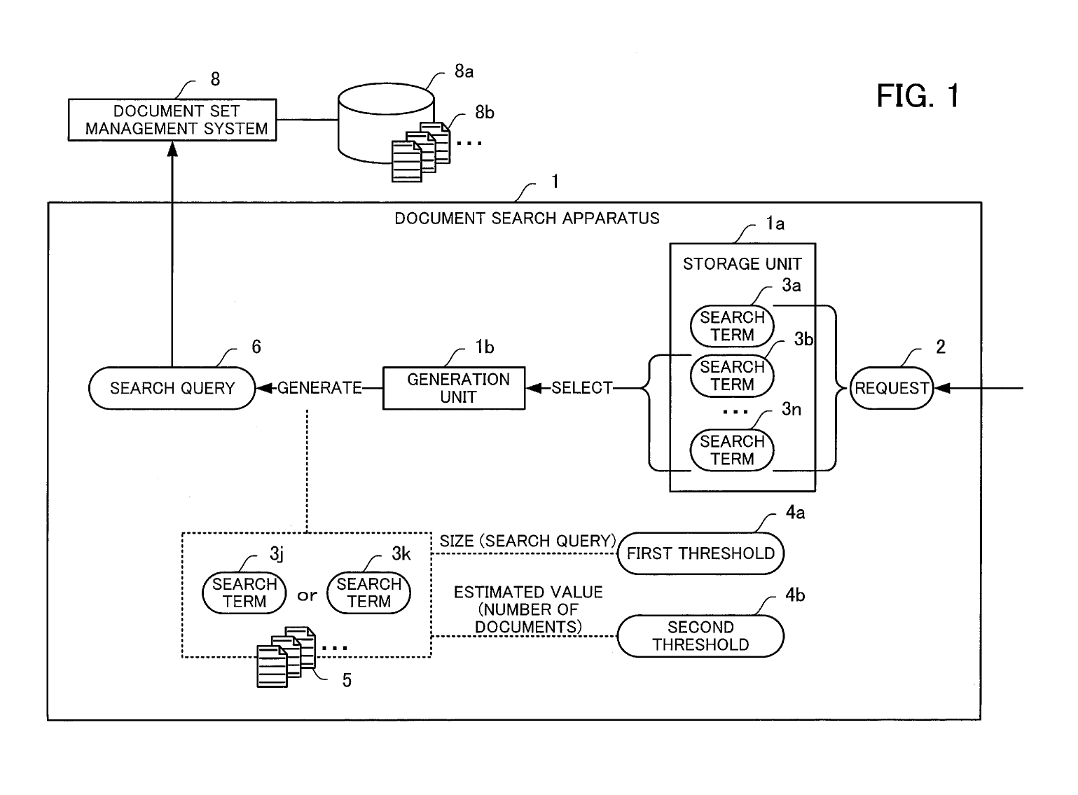

First, a document search apparatus 1 according to a first embodiment will be described with reference to FIG. 1. FIG. 1 illustrates an example of the configuration of the document, search apparatus 1 according to the first embodiment.

The document search apparatus 1 is an information processing apparatus that is connectable to a document set management system 8. The document set management system 8 provides a document search service that receives a search request and returns a set 8b of documents containing any of search terms included in the search request, as the results of a search in a document database 8a.

Upon providing the search service, the document set management system 8 imposes limits on the use of the search service by users. The limits on the use of the search service include, for example, a limit on the volume of a search input (the size of a search query, or the like), a limit on the, volume of a search output (for example, the number of documents to be output, or the like), a limit on the frequency of use, and so on. Due to these limits on the use of the document set management system 8, the user often needs to use the search service a number of times and spend a large amount of time so as to obtain the set 8b of documents containing any of the plurality of search terms.

The document search apparatus 1 receives a request (search request) 2 from the user, and issues to the document set management system 8 a search query 6 that is constructed in accordance with the limits on the use of the search service. Thus, the document search apparatus 1 obtains the set 8b of documents while reducing the number of uses of the search service.

The document search apparatus 1 includes a storage unit 1a and a generation unit 1b. The storage unit 1a stores a plurality of search terms (search terms 3a, 3b, . . . , and 3n). The storage unit 1a may be, for example, a random access memory (RAM) or the like. The search terms 3a 3b, . . . , and 3n specified in the request 2. The request 2 requests a search, for a document containing at least one of the search terms 3a, 3b, . . . , and 3n by using the document set management system 8.

The generation unit 1b selects two or more search terms for example, the search terms 3j and 3k) from the search terms 3a, 3b, . . . , and 3n. The generation unit 1b determines search terms to be selected such that a combination of the search terms satisfies predetermined conditions.

The predetermined conditions are that the size of the search query 6 is equal to or less than a first threshold 4a, and that an estimated value of the number of documents 5 to be retrieved by the document set management system 8 in response to the search query 6 is equal or less than a second threshold 4b.

The size of the search query 6 is an index corresponding to an input limit of the document set management system 8 and may be, for example, the number of characters included in the search query 6. Note that size of the search query S may be the number of search terms included in the search query 6. The first threshold 4a is a value corresponding to the input limit of the document set management system 8. For example, the first threshold 4a is set in advance and stored in the storage unit 1a.

The estimated value of the number of documents 5 to be retrieved by the document set management system 8 for the search query 6 is an index corresponding to an output limit of the document set management system 8 and may be, for example, the estimated value of the number of documents 5 to be output by the document set management system 8 as the search results of the search query 6. The estimated value is a value estimated using a predetermined estimation method. The second threshold 4b is a value corresponding to the output limit of the document set management system 8. For example, the second threshold 4b is set in advance and stored in the storage unit 1a.

For example, the generation unit 1b generates a search query 6 including a search expression “search term 3j or search term 3k”, from the thus selected combination of search terms 3j and 3k. The number of documents in the search results of the search query 6 is expected not to exceed the output limit of the document set management system 8. Accordingly, the document search apparatus 1 does not need to issue, again a search query 6 using the same search terms. Thus, the document search apparatus 1 is able to reduce the number of times that a search query 6 is issued under system restrictions the limits on the use of the document set management system 8).

### (b) Second Embodiment

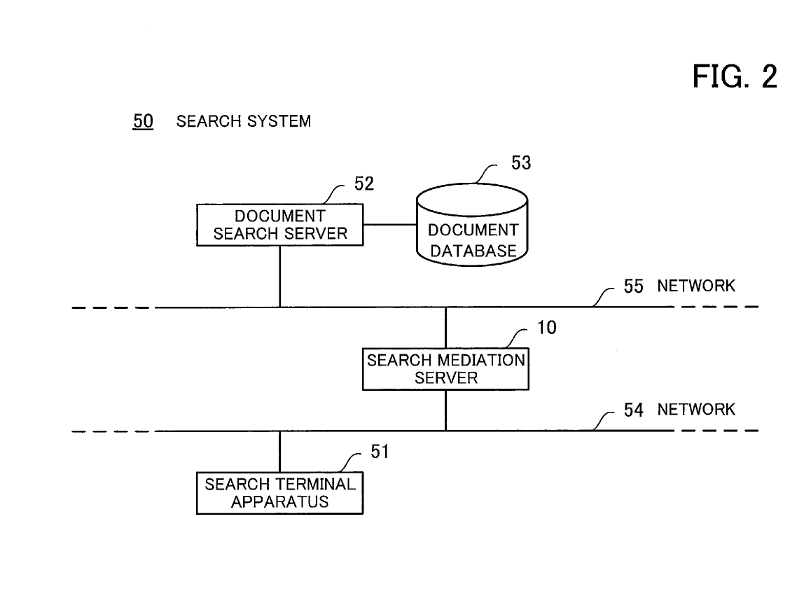

Next, a search system 50 according to a second embodiment will be described with reference to FIG. 2. FIG. 2 illustrates an example of the configuration of the search system 50 according to the second embodiment.

The search system 50 includes a search mediation server 10, a search terminal apparatus 51, a document search server 52, a document database and networks 54 and 55. The search system 50 provides a document search service, that receives a search request, and returns the results of a search in the document database 53. The search mediation server 10 is one form of a document search apparatus.

The search mediation server 10 connects to the search terminal apparatus 51 via the network 54, and connects to the document search server 52 via the network 55. Note that the search mediation server 10 may be one that includes the functions of the search terminal apparatus 51.

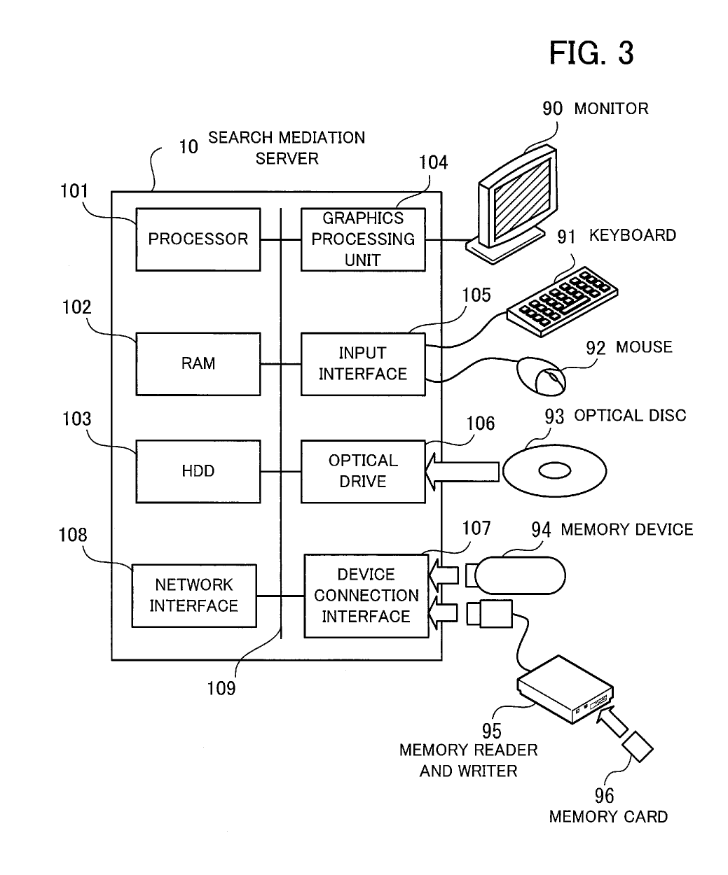

Next, the hardware, configuration of the search mediation server 10 will be described with reference to FIG. 3. FIG. 3 illustrates an example of the hardware configuration of the search mediation server 10 according to the second embodiment.

The overall operation of the search mediation server 10 is controlled by a processor 101. That is, the processor 101 serves as a control unit of the search mediation server 10. A RAM 102 and a plurality of peripheral devices are connected to the processor 101 via a bus 109. The processor 101 may be a multiprocessor. The processor 101 may be, for example, a central processing unit (CPU), a micro processing unit (MPU), a digital signal processor (DSP), an application specific integrated circuit (ASIC), or a programmable logic device (PLD). Alternatively, the processor 101 may be a combination of two or more selected from CPU, MPU, DSP, ASIC, and PLD.

The RAM 102 serves as a primary storage device of the search mediation server 10. The RAM 102 temporarily stores at least part of the operating system (OS) program and application programs that are executed by the processor 101. The RAM 102 also stores various types of data used for processing by the processor 101.

The peripheral devices connected to the bus 109 include a hard disk drive (HDD) 103, a graphics processing unit 104, an input interface 105, an optical drive 106, a device connection interface 107, and a network interface 108.

The HDD 103 magnetically writes data to and reads data from its internal disk. The HDD 103 serves as a secondary storage device of the search mediation server 10. The HDD 103 stores the OS program, application programs, and various types of data. Note that a semiconductor storage device such as a flash memory and the like may be used as a secondary storage device.

A monitor 90 is connected to the graphics processing unit 104. The graphics processing unit 104 displays an image on the screen of the monitor 90 in accordance with an instruction from the processor 101. Examples of the monitor 90 include a display device using a cathode ray tube (CRT), a liquid crystal display device, and the like.

A keyboard 91 and a mouse 92 are connected to the input interface 105. The input interface 105 receives signals from the keyboard 91 and the mouse 92, and transmits the received signals to the processor 101. The mouse 92 is an example of a pointing device, and other types of pointing devices may also be used. Examples of other types of pointing devices include a touch panel, a tablet, a touch pad, a track ball, and the like.

The optical drive 106 reads data from an optical disc 93 by using laser beams or the like. The optical disc 93 is a portable storage medium and stores data such that the data may be read through optical reflection. Examples of the optical disc 93 include digital versatile disc (DVD), DVD-RAM, compact disc read only memory (CD-ROM), CD-Recordable (CD-R), CD-Rewritable (CD-RW), and the like.

The device connection interface 107 is a communication interface that connects peripheral devices to the search mediation server 10. For example, a memory device 94 and a memory reader and writer 95 may be connected to the device connection interlace 107. The memory device 94 is a storage medium having a function to communicate with the device connection interface 107. The memory reader and writer 95 is a device that writes data to and reads data from a memory card 95. The memory card 96 is a card-type storage medium.

The network interface 108 is connected to the networks 54, and 55. The network interface 108 exchanges data with other computers including the search terminal apparatus 51 and the document search server 52, or communication apparatuses, via the networks 54 and 55.

With the hardware configuration described above, it is possible to realize the processing functions of the second embodiment. Note that the document search apparatus 1 illustrated in the first embodiment and the search terminal apparatus 51 and the document search server 52 illustrated in the second embodiment may also be realized with the same hardware as that of the search mediation server 10 illustrated in FIG. 3.

The search mediation server 10 realizes the processing functions of the second embodiment by executing a program stored in a computer-readable storage medium, for example. The program describing operations to be executed by the search mediation server 10 may be stored in various storage media. For example, the program to be executed by the search mediation server 10 may be stored in the HDD 103. The processor 101 loads at least part of the program from the HDD 103 into the RAM 102 so as to execute the program. The program to be executed by the search mediation server 10 may also be stored in a portable storage medium, such as the optical disc 93, the memo device 94, the memory card 96, and the like. The program stored in the portable recording medium may be executed after being installed into the HDD 103 under the control of, for example, the processor 101. Further, the processor 101 may execute the program by reading the program directly from the portable, storage medium.

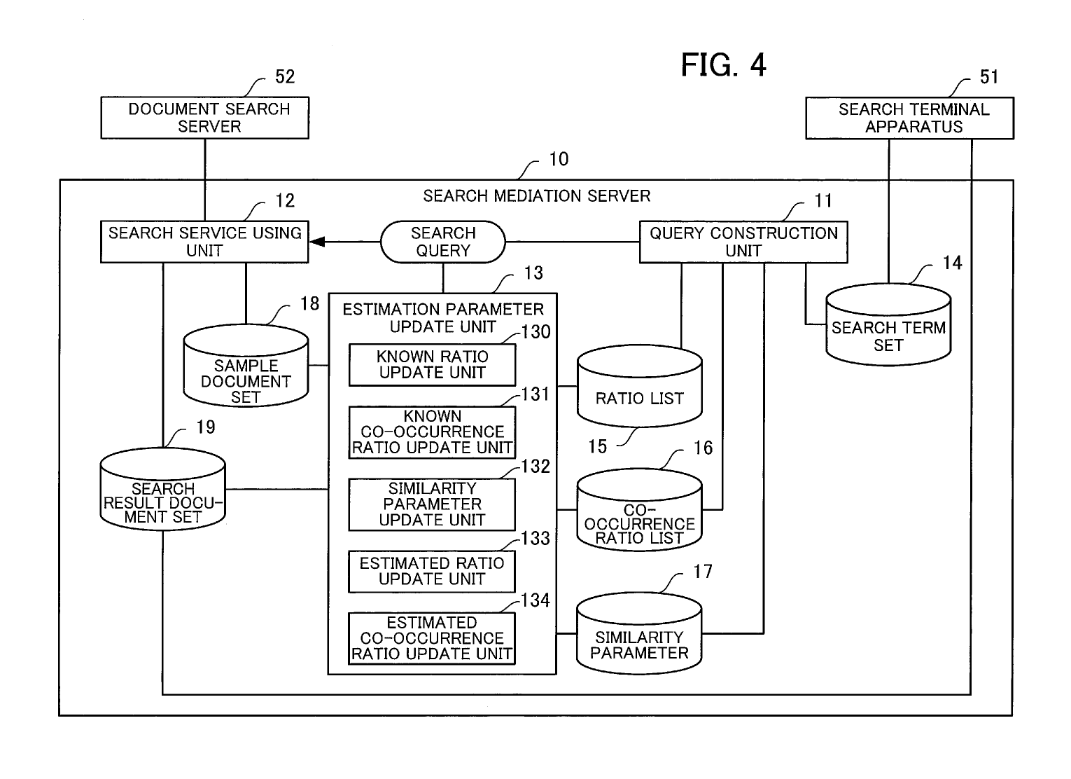

Next, the functional configuration of the search mediation server 10 will be described with reference to FIG. 4. FIG. 4 illustrates an example of the functional configuration of the search mediation server 10 according to the second embodiment.

The search mediation server 10 includes a query construction unit 11, a search service using unit 12, and an estimation parameter update unit 13. The search mediation server 10 is able to store a search term set 14, a ratio list 15, co-occurrence ratio list 16, a similarity parameter 17, a sample document set 18, and a search result document set 19, in the RAM 102 or the HDD 103. The RAM 102 and the HDD 103 serve as a storage unit of the search mediation server 10.

The search mediation server 10 generates the search term set 14 based on search terms included in a request (search request) received from the search terminal apparatus 51. Further, the search mediation server 10 returns the search results obtained from the document search server 52 to the search terminal apparatus 51.

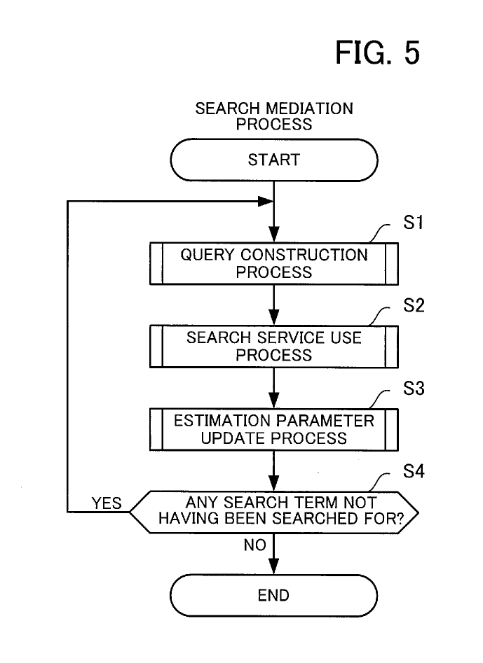

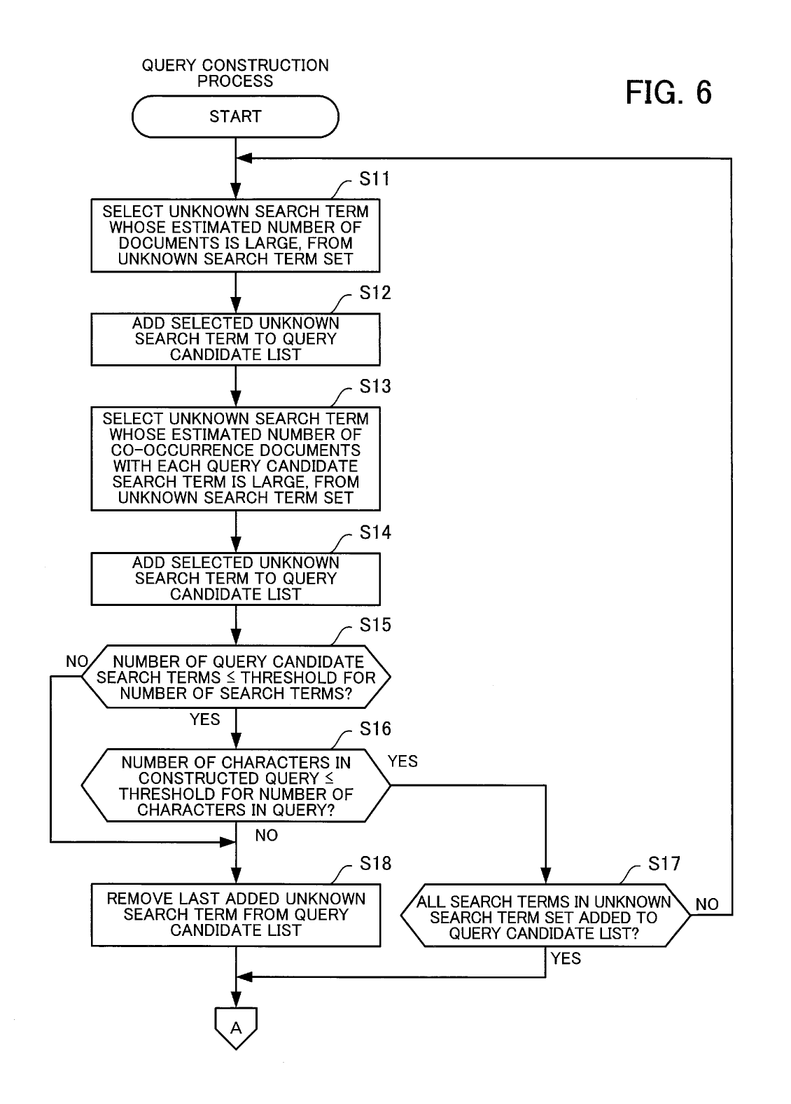

The query construction unit 11 constructs a search query from the search terms included in the search term set 14 cared various preset parameters. The various preset parameters include the ratio list 15, the co-occurrence ratio list 16, and the similarity parameter 17. The query construction unit is realized when, for example, the processor 101 executes a query construction process that will be described below with reference to FIGS. 5 through 7. The query construction unit 11 has a function of the generation unit 1b of the first embodiment.

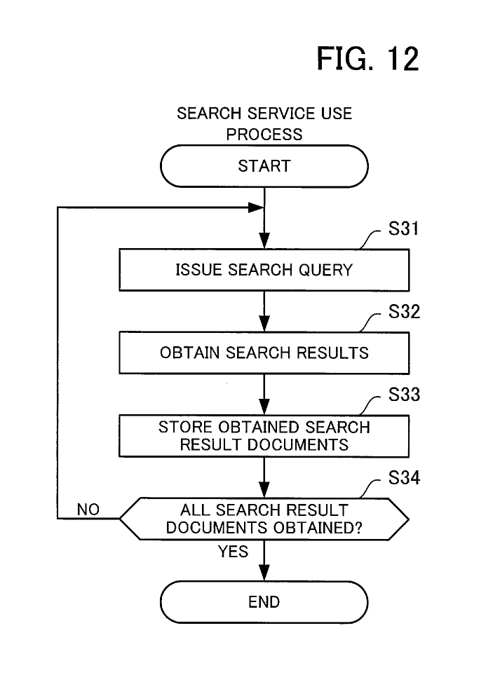

The search service using unit 12 uses a search service provided by the document search server 52 using a search query. The search service using unit 12 generates the search result document set 19 from the search results. Further, the search service using unit 12 generates a sample document set 18 by obtaining sample documents from the document search server 52 in advance. The sample document set 18 is a subset extracted from the entire set of documents held by the document database 53 that is managed by the document search server 52. The search service using unit 12 is realized when, for example, the processor 101 executes a search service use process that will be described below with reference to FIGS. 5 and 12.

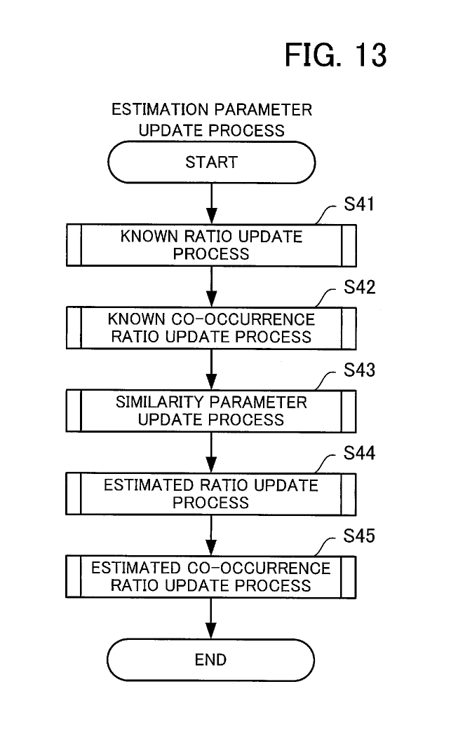

The estimation parameter update, unit 13 updates various parameters used for constructing a search query, based on the search results. More specifically, the estimation parameter update unit 13 updates the ratio list 15, the co-occurrence ratio list 16, and the similarity parameter 17, based on a search query, the sample document set 18, and the search result document set 19. The estimation parameter update unit 13 includes a known ratio update unit 130, a known co-occurrence ratio update unit 131, a similarity parameter update unit 132, an estimated ratio update unit 133, and an estimated co-occurrence ratio update unit 134. The estimation parameter update unit 13 is realized, when, for example, the processor 101 executes an estimation parameter update process that will be described below with reference to FIGS. 5 and 13.

The known ratio update unit 130 updates the ratio list 15 for the ratio (known ratio) of a search term (known search term) for which search results have already been obtained. The known co-occurrence ratio update unit 131 updates the co-occurrence ratio list 16 for the co-occurrence ratio (known co-occurrence ratio) of a combination of known search terms. The similarity parameter update unit 132 updates the similarity parameter 17 used for calculation of the similarity between search terms. The estimated ratio update unit 133 updates the ratio list 15 for the estimated value of the ratio (estimated ratio) of a search term (unknown search term) for which search results have not been obtained. The estimated co-occurrence ratio update unit 134 updates the co-occurrence ratio list 16 for the estimated value of the co-occurrence ratio (estimated co-occurrence ratio) of a combination of search terms for which a known co-occurrence ratio has not been calculated.

Next, a search mediation process will be described with reference to FIG. 5. FIG. 5 is a flowchart of a search mediation process according to the second embodiment. The search mediation process is a process executed by the search mediation server 10 upon receiving a search request.

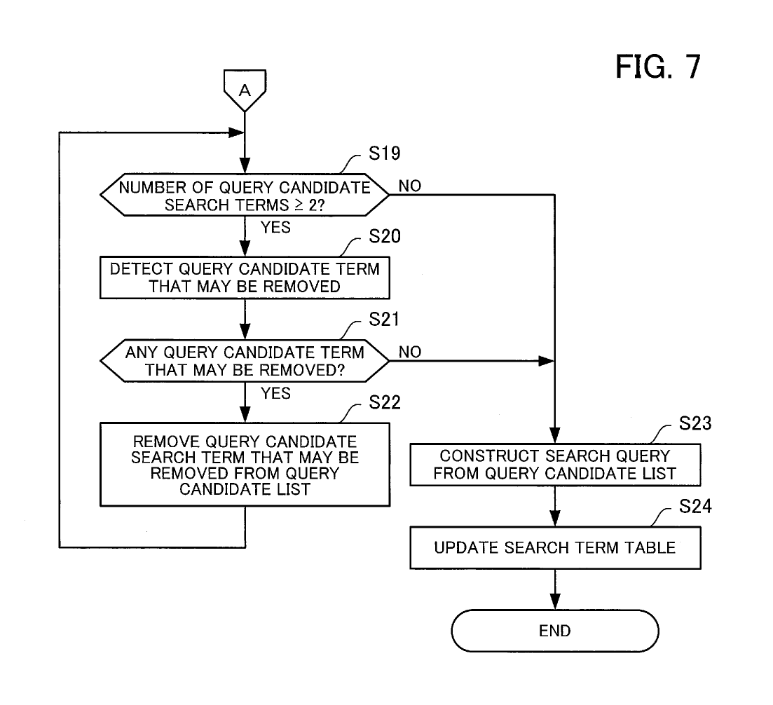

(Step S1) The query construction unit 11 executes a query construction process that constructs a search query based on search terms included in a received search request and various preset parameters. The query construction process will be described below with reference to FIGS. 6 and 7.

(Step S2) The search service using unit 12 issues the search query, and executes a search service use process that uses a search service provided by the document search server 52. The search service use process will be described below with reference to FIG. 12.

(Step S3) The estimation parameter update unit 13 executes an estimation parameter update process that updates various parameters used for constructing a search query, based on the search results. The estimation parameter update process will be described below with reference to FIG. 13.

(Step S4) The search mediation server 10 (control unit) determines whether there is any unknown search term that has not been used for a search, among the search terms included in the received search request. If there is an unknown search term, the process returns to step S1. If there is no unknown search term, the search mediation process ends.

In this manner, the search mediation server 10 repeats the operations of steps S1 through S4, and obtains the search results for all the search terms included in the received search request. In this process, the search mediation server 10 updates the parameters each time the search mediation server 10 issues a search query and receives the search results. The parameters to be referred to when generating the next search query are the updated parameters. Thus, the efficiency of use of the search service is improved for later search queries.

Next, a query construction process will be described with reference to FIGS. 6 and 7. FIGS. 6 and 7 are flowcharts of a query construction process according to the second embodiment. The query construction process is a process executed by the query construction unit 11 in step S1 of the search mediation process.

(Step S11) The query construction unit 11 selects an unknown search term whose estimated number of documents is large, from an unknown search term set. The estimated number of documents indicates the estimated value of the number of documents containing a search term among the documents stored in the document database 53. The query construction unit 11 is able to calculate the estimated number of documents based on the sample document set 18 and the ratio list 15. For example, the query construction unit 11 searches for sample documents containing an unknown search term from the sample document set 18, multiplies the number of such sample documents by an estimated ratio corresponding to the unknown search term, and thereby calculates the estimated number of documents. Note that in the case where step S1 described above is executed for the first time and step S3 has not been executed, all the estimated ratios may be initialized to 1. In this case, the number of sample documents obtained from the sample document set 18 is regarded as the estimated number of documents.

The unknown search term set is a set of unknown search terms for which a search has not been performed, among the search terms included in the search term set 14. In the initial state, the unknown search term set is equivalent to the search term set 14.

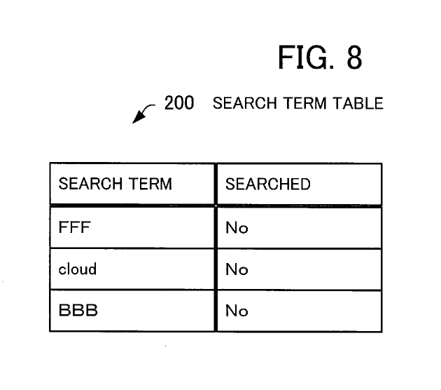

In the following, a search term table used for detecting an unknown search term set will be described with reference to FIG. 8. FIG. 8 illustrates an example of a search term table 200 according to the second embodiment. The search term table 200 includes the item “search term” and the item “searched”. The item “search term” indicates a search term included in the search term set 14. The item “searched” indicates, with “Yes” or “No”, whether the search term has been searched for. The value “Yes” indicates that the search term is a known search term, and the value indicates that the search term is an unknown search term. Accordingly, the search term table 200 of FIG. 8 indicates that all the search terms “FFF”, “cloud”, and “BBB” are unknown search terms.

(Step S12) The query construction unit 11 adds the unknown search term selected in step S11 to a query candidate list.

(Step S13) The query construction unit 11 selects an unknown search term whose sum of the estimated number of co-occurrence documents in which the unknown search term and each unknown search term (query candidate search term) on the query candidate list co-occur is large, from the unknown search term set. The estimated number of co-occurrence documents indicates the estimated value of the number of documents (documents satisfying an AND condition of a plurality of search terms) containing all the search terms included in a combination of search terms, among the documents stored in the document database 53. The query construction unit 11 is able to calculate the estimated number of co-occurrence documents based on the sample document set 18 and the co-occurrence ratio list 16. For example, the query construction unit 11 searches for sample documents containing both of two unknown search terms from the sample document set 18, multiplies the number of such sample documents by an estimated co-occurrence ratio corresponding to a combination of the two unknown search terms, and thereby calculates the estimated number of co-occurrence documents. Note that in the case where step S1 described above is executed for the first time and step S3 has not been executed, all the estimated co-occurrence ratios may be initialized to 1. In this case, the number of sample documents obtained from the sample document set 18 is regarded as the estimated number of co-occurrence documents.

(Step S14) The query construction unit 11 adds the unknown search term selected in step S13 to the query candidate list.

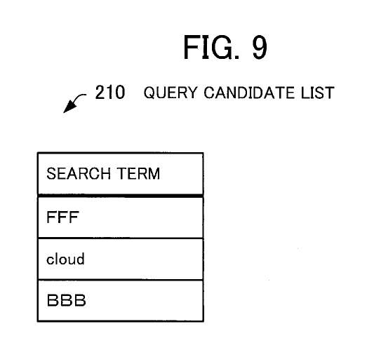

In the following, the query candidate list will be described with reference to FIG. 9. FIG. 9 illustrates an example of a query candidate list 210 according to the second embodiment. The query candidate list 210 includes the item “search term”. The item “search term” indicates the unknown search term added by the query construction unit 11 in step S12 or step S14. The query candidate list 210 indicates that the search terms “FFF”, “cloud”, and “BBB” are added by the query construction unit 11 in step S12 or step S14.

(Step S15) The query construction unit 11 determines whether the number of query candidate search terms is equal to or less than a threshold for the number of search terms for example, 10 terms). If the number of query candidate search terms is equal to or less than the threshold for the number of search terms, the process proceeds to step S16. If not, the process proceeds to step S18.

The threshold for the number of search terms is the upper limit of the number of search terms that may be included in a search query. The threshold for the number of search terms is defined by, for example, the search service provided by the document search server 52. Alternatively, the threshold for the number of search terms may be set by the search mediation server 10. The threshold for the number of search terms is one of the thresholds that limit the size of a search query.

(Step S16) The query construction unit 11 determines whether, when a search query including all the query candidate search terms is constructed, the number of characters in the search query is equal to or less than a threshold for the number of characters in a query (for example, 1,000 characters). If, when the search query is constructed, the number of characters in the search query is equal to or less than the threshold for the number of characters in a query, the process proceeds to step S17. If not, the process proceeds to step S18.

The threshold for the number of characters in a query is the upper limit of the number of characters in a search query. Note that the threshold for the number of characters in a query is defined by, for example, the search service provided by the document search server 52. Alternatively, the threshold for the number of characters in a query may be set by the search mediation server 10. The threshold for the number of characters in a query is one of the thresholds that limit the size of a search query.

(Step S17) The query construction unit 11 determines whether all the search terms included in the unknown search term set have been added to the query candidate list. If all the search terms included in the unknown search term set have been added to the query candidate list, the process proceeds to step S19. If not all the search terms included in the unknown search term set have been added to the query candidate list, the process returns to step S11.

(Step S18) The query construction unit 11 removes the last added unknown search term from the query candidate list. Thus, the query construction unit 11 corrects the limit on the size of a search query violated by the last added unknown search term.

(Step S19) The query construction unit 11 determines whether there are two or more query candidate, search terms. If there are two or more query candidate search terms, the process proceeds to step S20. If there are not two or more query candidate search terms, the process proceeds to step S23.

(Step S20) The query construction unit 11 detects a query candidate search term that may be removed from the query candidate list. A query candidate search term may be removed from the query candidate list if, by removing the query candidate search term from the query candidate list, the estimated number of documents corresponding to a search query constructed with the remaining query candidate search terms becomes more preferable than that before the removal thereof. The estimated number of documents is preferable when the estimated number of documents is equal to an integral multiple of the number of documents (output limit number) that may be obtained from the document search server 52 in one batch, or is close to and less than the integral multiple. In other words, the estimated number of documents is not preferable when the estimated number of documents is slightly greater than an integral multiple of the output limit number. By bringing the estimated number of documents to a preferable value, it is possible to increase, within the output limit, the number of documents that may be obtained in one batch from the document search server 52, and to reduce the number of times a search query is issued.

For example, the query construction unit 11 may use an expression (1) as one example of evaluating each candidate combination of unknown search terms based on the difference between an estimated total number of documents F and an integral multiple of an output limit number S. The query construction unit 11 determines that the query candidate search term may be removed from the query candidate list if the value of the expression (1) is closer to “0” than that before the removal thereof.

S−{(F−1)mod S}−1 (1)

Note that the output limit number S is defined by, for example, the search service provided by the document search server 52. Alternatively, the output limit number S may be set by the search mediation server 10. The output limit number S is one of the threshold for the estimated number of documents to be retrieved by the search service provided by the document search server 52.

The estimated total number of documents F is the number of documents containing at least one of two or more query candidate search terms among the documents stored in the document database 53, that is, the number of documents that satisfies an OR condition of two or more query candidate search terms. The estimated total number of documents F may be calculated from the estimated number of documents of each query candidate search term and the estimated number of co-occurrence documents of each combination of two query candidate search terms (each two query candidate search terms combined with the AND operator).

The query construction unit 11 is able to determine the estimated number of documents of each query candidate search term based on the sample document set 18 and the ratio list 15. For example, the query construction unit 11 searches for sample documents containing a query candidate search term from the sample document set 18, multiplies the number of such sample documents by an estimated ratio corresponding to the query candidate search term, and thereby calculates the estimated number of documents.

Further, the query construction unit 11 is able to determine, based on the estimated number of co-occurrence documents containing two query candidate search terms included in the query candidate list and the co-occurrence ratio list 16, the estimated number of co-occurrence documents containing both of the two query candidate search terms. For example, the query constructs unit 11 searches for sample documents containing both of two query candidate search terms from the sample document set 18, multiplies the number of such documents (the number of sample co-occurrence documents) by an estimated co-occurrence ratio corresponding to a combination of these query candidate search terms, thereby calculates the estimated number of co-occurrence documents.

In this manner, the query construction unit 11 is able to calculate the estimated total number of documents F. For example, the query construction unit 11 calculates the sum of the estimated number of documents of each query candidate search term included in the query candidate list, and calculates the sum of the estimated number of co-occurrence documents of each combination of query candidate search terms included in the query candidate list. Then, the query construction unit 11 calculates the estimated total number of documents F by subtracting the sum of the estimated number of co-occurrence documents from the sum of the estimated number of documents. In this embodiment, in order to simplify the calculation, the estimated total number of documents F is calculated without considering the effects of documents containing three of more query candidate search terms. However, the query construction unit 11 may calculate the estimated total number of documents F more precisely. In this case, the co-occurrence ratio corresponding to a combination of three or more search terms is also registered in the co-occurrence ratio list 16.

For example, suppose that a query candidate list includes search terms “A”, “B”, and “C”. In this case, the query construction unit 11 refers to the sample document set 18, and calculates the number of sample documents containing the search term “A”, the number of sample documents containing the search term “B”, and the number of sample documents containing the search term “C”. Further, the query construction unit 11 refers to the sample document set 18, and calculates the number of sample co-occurrence documents containing a combination of search terms “A” and “B”, the number of sample co-occurrence documents containing a combination of search terms “A” and “C”, and the number of sample co-occurrence documents containing a combination of search terms “B” and “C”. Further, the query construction unit 11 searches for the estimated ratio of the search term “A”, the estimated ratio of the search term “B”, and the estimated ratio of the search term “C”, from the ratio list 15. Further, the query construction unit 11 searches for the estimated co-occurrence ratio of the combination of search terms “A” and “B”, the estimated co-occurrence ratio of the combination of search terms “A” and “C”, and the estimated co-occurrence ratio of the combination of search terms “B” and “C”, from the occurrence ratio list 16. The estimated total number of documents F may be calculated based on the numbers of sample documents, the numbers of sample co-occurrence documents, the estimated ratios, and the estimated co-occurrence ratios.

Note that in a situation in which the number of documents containing two or more unknown search terms is less than the number of documents containing each unknown search term and negligible, it is possible to calculate the estimated total number of documents F more simply. For example, the query construction unit 11 may calculate, the estimated total number of documents F from the number of sample documents and the estimated ratio of each unknown search term, while assuming the estimated co-occurrence ratio=0. In this case, the search mediation server 10 does not need to include the co-occurrence ratio list 16. Further, the query construction unit 11 does not need to search for sample co-occurrence documents containing both of two unknown search terms from the sample document set 18.

Note that the ratio list 15, the co-occurrence ratio list 16, and the similarity parameter 17 may be initialized each time a search request is received from the search terminal apparatus 51, or may be maintained for a plurality of search requests. In the latter case, a previously calculated known ratio has often been registered for a certain query candidate search term, in the ratio list 15. Further, a previously calculated known co-occurrence ratio has often been registered for a certain combination of query candidate search terms, in the co-occurrence ratio list 16.

In this case, the query construction unit 11 may use the known ratio when the known ratio has been calculated, and may use an estimated ratio when the known ratio has not been calculated. That is, the known ratio is used preferentially over the estimated ratio. Further, the query construction unit 11 may use the know co-occurrence ratio if the known co-occurrence ratio has been calculated, and may use an estimated co-occurrence ratio when the known co-occurrence ratio has not been calculated. That is the known co occurrence ratio is used preferentially over the estimated co-occurrence ratio. The known ratio, the estimated ratio, the known co-occurrence ratio, and the estimated co-occurrence ratio will be described below together with the estimation parameter update unit 13.

(Step S21) The query construction unit 11 determines whether there is any query candidate search term that may be removed from the query candidate list. If there is a query candidate search term that may be removed from the query candidate list, the process proceeds to step S22. If there is no query candidate search term that may be removed from the query candidate list, the process proceeds to step S23.

(Step S22) The query construction unit 11 removes, from the query candidate list, the query candidate search term that may be removed from the query candidate list. Then, the process returns to step S19 in which the query construction unit 11 further detects a query candidate search term that may be removed from the query candidate list.

(Step S23) The query construction unit 11 constructs (generates) a search query from the query candidate list. More specifically, the query construction unit 11 constructs a search query by combining query candidate search terms included in the query candidate list with the OR operator.

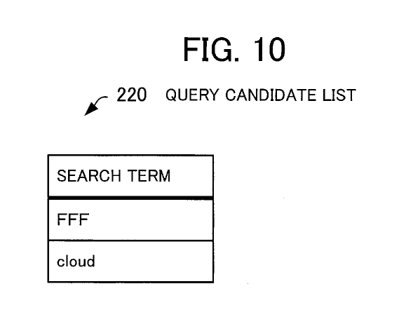

An example of the query candidate list after removal of search terms in steps S19 through S22 is illustrated in FIG. 10. FIG. 10 illustrates an example of a query candidate list 220 according to the second embodiment. The query candidate list 220 indicates that the search term “BBB” is removed from the query candidate list 210. A search query constructed from the query candidate list 220 is “FFF OR cloud”.

(Step S24) The query construction unit 11 updates the search term table, and then the query construction process ends.

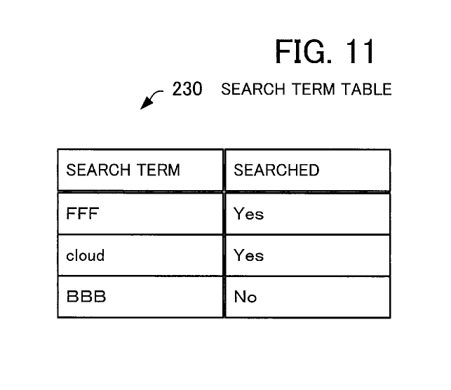

An example of the search term table updated in step S24 is illustrated in FIG. 11. FIG. 11 illustrates an example of a search term table 230 according to the second embodiment. In the search term table 230, the item “searched” is “Yes” for the search terms “FFF” and “cloud”, and the item “searched” is “No” for the search term “BBB”. Accordingly, the search term table 230 indicates that the search query “FFF OR cloud” been constructed and therefore the search terms “FFF” and “cloud” are regarded as having been searched for. Further, the search term table 230 indicates that the search term “BBB” is still an unknown search term. Note that although the search term table is updated by the query construction unit 11 before the search query is issued, the search term table may be updated after the search query is issued by the search service using unit 12.

In this manner, the query construction unit 11 is able to appropriately calculate the estimated total number of documents corresponding to an unknown search term set combined with the OR operator, and issue a search query that allows obtaining documents within the range of the search service provided by the document search server 52. By issuing such a search query, the search mediation server 10 is able to reduce the total number of times a search query is issued to the document search server 52.

Next, a search service use process will be described with reference to FIG. 12. FIG. 12 is a flowchart of a search service use process according to the second embodiment. The search service use process is a process executed by the search service using unit 12 in step S2 of the search mediation process.

(Step S31) The search service using unit 12 issues the search query constructed in the query construction process to the document search server 52.

(Step S32) The search service using unit 12 obtains the search result documents for the issued search query from the document search server 52. The maximum number of search result documents that may be obtained by the search service using unit 12 in one batch is the output limit number S. For example, when the number of search result documents is 200 and the output limit number S is 100, the search service using unit 12 may obtain 100 search result documents in one batch.

(Step S33) The search service using unit 12 stores the obtained search result documents as a part of the search result document set 19.

(Step S34) The search service using unit 12 determines whether all the search result documents have been obtained. If not all the search result documents have been obtained, the process returns to step S31. If all the search result documents have been obtained, the search service use process ends.

A determination as to whether all the search result documents have been obtained may be made based on, for example, control information included in a response from the document search server 52. For example, the response from the document search server 52 includes the number of search result documents for the search query, and information indicating the starting number of the documents included in the response among all the search result documents. If not all the search result documents have been obtained, the search service using unit 12 transmits to the document search server 52 a search query including the same search terms as those included last time, while specifying the starting number of the documents that have not been obtained. For example, in the case where the output limit number S is 100, if a response indicating that the number of search result documents is 200 and the starting number is 0, the search service using unit 12 transmits a search query including the same search terms as those included last time, while specifying 100 as the starting number. Thus, all the search result documents are obtained.

In this manner, the search service using unit 12 uses the search service, one or more times depending on the number of search result documents, and obtains all the search result documents corresponding to a combination of unknown search terms. In this case, if the search query is constructed to satisfy the expression (1), the search mediation server 10 is able to maximize the estimated total number of documents F within the output limit number S. Accordingly, the search mediation server 10 is able to use the search service efficiently.

Next, an estimation parameter update process will be described with reference to FIG. 13. FIG. 13 is a flowchart of an estimation parameter update process according to the second embodiment. The estimation parameter update process is a process executed by the estimation parameter update unit 13 in step S3 of the search mediation process.

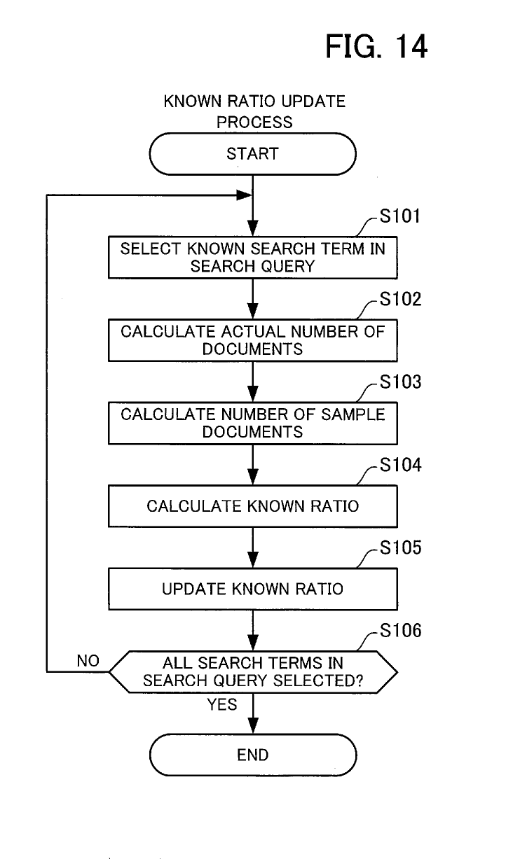

(Step S41) The estimation parameter update unit 13 (the known ratio update unit 130) executes a known ratio update process. The known ratio update process is a process that calculates the known ratio of a known search term included in the currently issued search request, and updates the ratio list 35. The details of the known ratio update process will be described below with reference to FIG. 14.

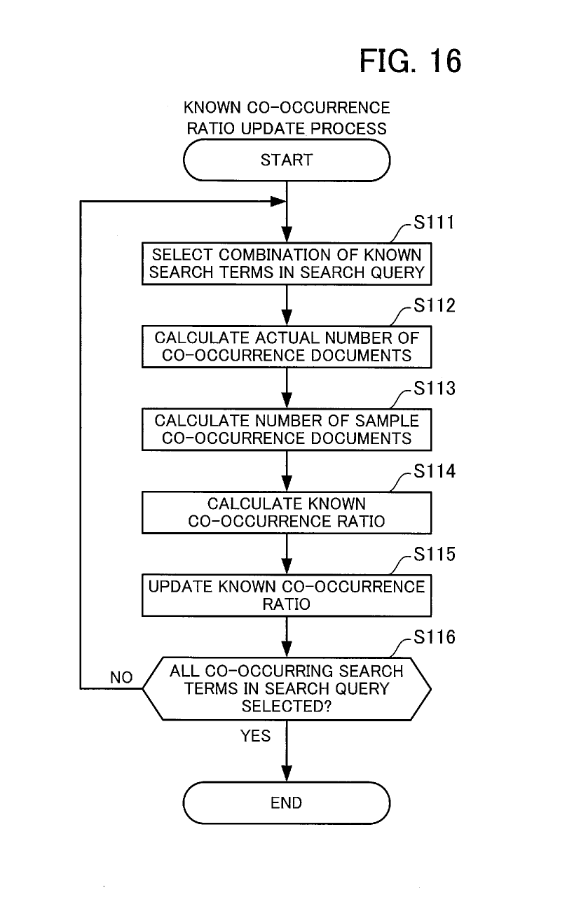

(Step S42) The estimation parameter update unit 13 (the known co-occurrence ratio update unit 131) executes a known co-occurrence ratio update process. The known co-occurrence ratio update process is a process that calculates the known co-occurrence ratio of a combination of known search terms included in the currently issued search request, and updates the co-occurrence ratio list 16. The details of the known co-occurrence ratio update, process will be described below with reference to FIG. 16.

(Step S43) The estimation parameter update unit 13 (the similarity parameter update unit 132) executes a similarity parameter update process. The similarity parameter update process is a process that updates the similarity parameter 17 used for calculation of the similarity between two search terms. The similarity parameter is an index indicating the degree of importance of each neighboring word that appears in the neighborhood of two search terms in the search result document set 19. The, degree of importance of each neighboring word takes, for example, a value in the range, from “0.0” to “1.0”. The closer to “1.0” the value is, the more important the neighboring word is evaluated to be. The neighborhood of a search term may be defined as, for example, a range within the sentence containing the search term or a predetermined range preceding and following the search term (the preceding and following 5 words or the like).

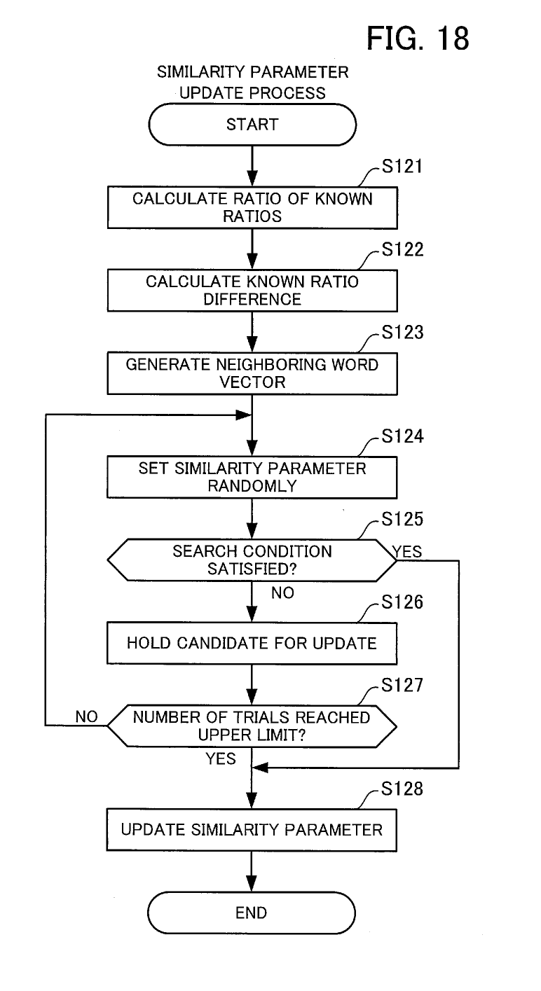

The details of the similarity parameter update process will be described below with reference to FIG. 18.

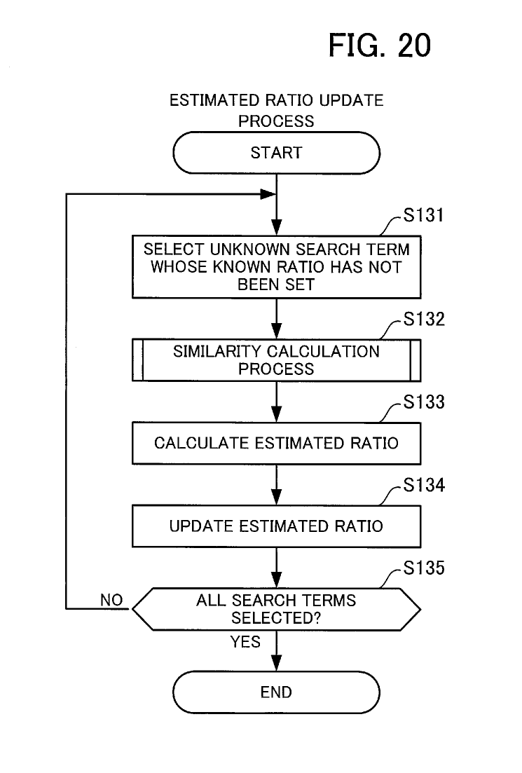

(Step S44) The estimation parameter update unit 13 (the estimated ratio update unit 133) executes an estimated ratio update process. The estimated ratio update process is process that calculates the estimated ratio of an unknown, search term based on the similarity between a known search term and the unknown search term, and updates the ratio list 15. The details of the estimated ratio update process will be described below with reference to FIG. 20.

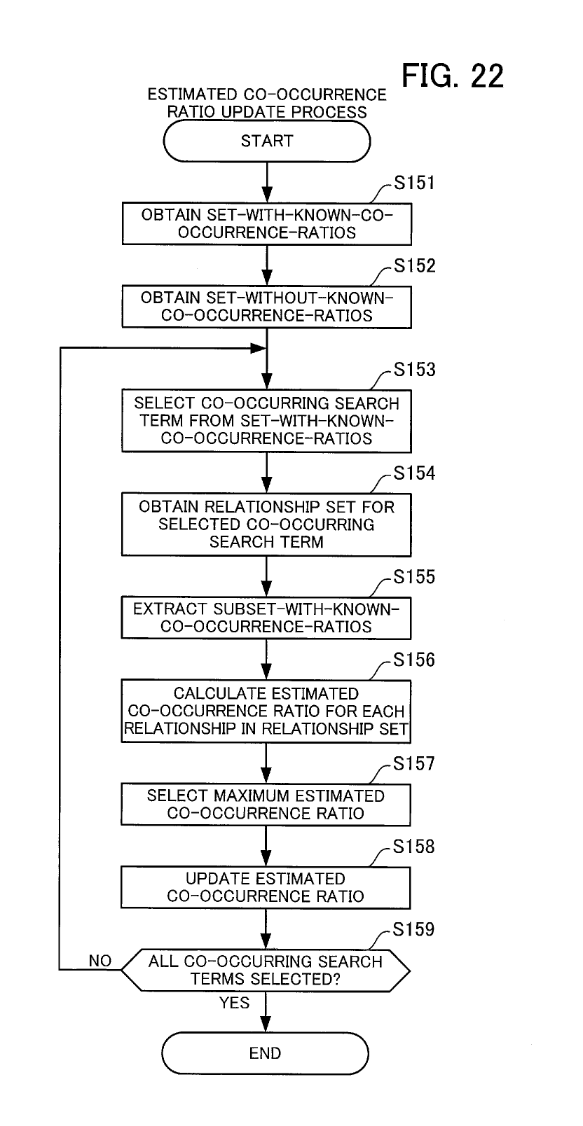

(Step S45) The estimation parameter update unit 13 (the estimated co-occurrence ratio update unit 134) executes an estimated co-occurrence ratio update process. The estimated co-occurrence ratio update process is a process that calculates the estimated co-occurrence ratio of a combination of search terms for which a known co-occurrence ratio has not been calculated, and updates the co-occurrence ratio list 16. The details of the estimated co-occurrence ratio update process will be described below with reference to FIG. 22.

After the estimation parameter update unit 13 executes the estimated co-occurrence ratio update process, the estimation parameter update process ends.

In this manner, the search mediation server 10 updates various parameters each time the search mediation server 10 uses the search service. Thus, by constructing a search query using the updated various parameters, the search mediation server 10 is able to efficiently use the search service when using the search service next time.

Next, a known ratio update process will be described with reference to FIG. 14. FIG. 14 is a flowchart of a known ratio update process according to the second embodiment. The known ratio update process is a process executed by the known ratio update unit 130 in step S41 of the estimation parameter update process.

(Step S101) The known ratio update unit 130 selects a known search term included in the currently issued search query. For example, the know ratio update unit 130 selects the search term “FFF” out of the search term “FFF” and the search term “cloud” included in the search query “FFF OR cloud”.

(Step S102) The known ratio update unit 130 calculates the number of documents (the actual number of documents) containing the known search term selected in step S101, among the currently obtained search result documents. For example, the known ratio update unit 130 obtains “10,000” as the actual number documents containing the search term “FFF”.

(Step S103) The known ratio update unit 130 calculates the number of sample documents containing the known search term selected in step S101 among the sample documents included in the sample document set 18. For example, the known ratio update unit 130 obtains “10” as the number of sample documents containing the search term “FFF”.

(Step S104) The known ratio update unit 130 calculates the ratio (known ratio) of the actual number of documents and the number of sample documents. For example, the known ratio update unit 130 obtains “1,000 (=10,000/10)” as the known ratio for the search term “FFF”.

(Step S105) The known ratio update unit 130 updates the ratio list 15 with the calculated known ratio.

(Step S106) The known ratio update unit 130 determines whether all the known search terms included in the currently issued search query have been selected. If not all the known search terms included in the search query have been selected, the process returns to step S101.

For example, when the search term “cloud” out of the search terms “FFF” and “cloud” included in the search query has not been selected, the process returns to step S101 in which the known ratio update unit 130 selects the search term “cloud”. Subsequently, in steps S102 through S104, the known ratio update unit 130 obtains “8,000” as the actual number of documents, “8” as the number of sample documents, and “1,000 (−8,000/8)” as the known ratio, for the search term “cloud”.

On the other hand, if all the known search terms included in the search query have been selected, the known ratio update process ends.

In this manner, the known ratio update unit 130 is able to update the ratio list 15 with the known ratios calculated for the search terms included in the search query.

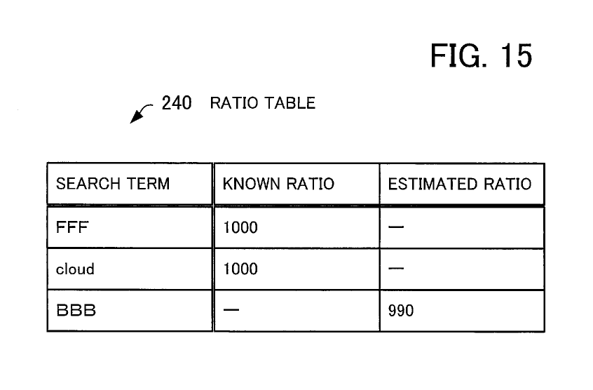

In the following, the data configuration of the ratio list 15 will be described with reference to FIG. 15. FIG. 15 illustrates an example of a ratio table 240 according to the second embodiment.

The ratio table 240 is included in the ratio list 15. The ratio table 240 includes the item “search term”, the item “known ratio”, and the item “estimated ratio”. The item “search term” indicates a search term included in the search term set 14. The item “known ratio” indicates the known ratio of the search term. The item “estimated ratio” indicates the estimated ratio of the search term.

In the ratio table 240, the known ratio “1,000” is recorded for the search term “FFF” and the known ratio “1,000” is recorded for the search term “cloud” based on the known ratio update process executed after issuance of the search query “FFF OR cloud”. The item “estimated ratio” for each of the search terms “FFF” and “cloud” indicates an estimated ratio of “−” because the item “known ratio” is recorded.

Next, a known co-occurrence ratio update process will be described with reference to FIG. 16. FIG. 16 is a flowchart of a known co-occurrence ratio update process according to the second embodiment. The known co-occurrence ratio update process is a process executed by the known co-occurrence ratio update unit 131 in step S42 of the estimation parameter update process.

(Step S111) The known co-occurrence ratio update unit 131 selects a combination of two search terms (a combination of search terms is hereinafter also referred to as a co-occurring search term) included in the currently issued search query. For example, the known co-occurrence ratio update unit 131 selects a co-occurring search term “FFF & cloud” including a combination of the search term “FFF” and the search term “cloud”, from the search query “FFF OR cloud”.

(Step S112) The known co-occurrence ratio update unit 131 calculates the number of documents (the actual number of co-occurrence documents) containing the co-occurring search term selected in step S111, among the currently obtained, search result documents. For example, the known co-occurrence ratio update unit 131 obtains “3,000” as the actual number of co-occurrence documents IS containing the co-occurring search term “FFF & cloud”.

(Step S113) The known co-occurrence ratio update unit 131 calculates the number of sample documents (the number of sample co-occurrence documents) containing the known co-occurring search term selected in step S111 among the sample documents included in the sample document set 18. For example, the known co-occurrence ratio update unit 131 obtains “3” as the number of sample co-occurrence documents containing the co-occurring search term “FFF & cloud”.

(Step S114) The known co-occurrence ratio update unit 131 calculates the ratio (known co-occurrence ratio) of the actual number of co-occurrence documents and the number of sample co-occurrence documents. For example, the known co-occurrence ratio update unit 131 obtains a known co-occurrence ratio “1,000 (=3,000/3)” for the co-occurring search term “FFF & cloud”.

(Step S115) The known co-occurrence ratio update, unit 131 updates the co-occurrence ratio list 16 with the calculated known co-occurrence ratio.

(Step S116) The known co-occurrence ratio update unit 131 determines whether all the co-occurring search terms included in the currently issued search query have been selected. If not all the co-occurring search terms included in the search query have been selected, the process returns to step S111. If all the co-occurring search terms included in the search query have been selected, the known co-occurrence ratio update process ends.

In this manner, the known co-occurrence ratio update unit 131 is able to update the co-occurrence ratio list 16 with the known co-occurrence ratios calculated for the co-occurring search terms included in the search query.

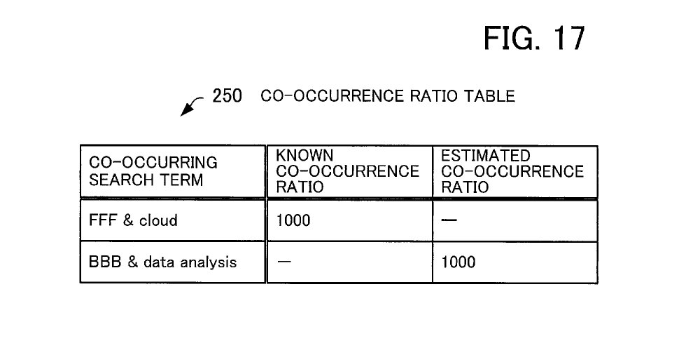

In the following, the data configuration of the co-occurrence ratio list 16 will be described with reference to FIG. 17. FIG. 17 illustrates an example of a co-occurrence ratio table 250 according to the second embodiment.

The co-occurrence ratio table 250 is included in the co-occurrence ratio list 16. The co-occurrence ratio table 250 includes the item “co-occurring search term”, the item “known co-occurrence ratio”, and the item “estimated co-occurrence ratio”. The item “co-occurring search term” indicates a co-occurring search term included in the search term set 14. The item “known co-occurrence ratio” indicates the known co-occurrence ratio of the co-occurring search term. The item “estimated co-occurrence ratio” indicates the estimated co-occurrence ratio of the co-occurring search term.

In the co-occurrence ratio table 250, the known co-occurrence ratio “1,000” is recorded for the co-occurring search term “FFF & cloud” based on the known co-occurrence ratio update process executed after issuance of the search query “FFF OR cloud”. The item “estimated co-occurrence ratio” for the co-occurring search term “FFF & cloud” indicates an estimated co-occurrence ratio of “−” because the item “known co-occurrence ratio” is recorded.

Note that although the search mediation server 10 selects a combination of two search terms as a co-occurring search term, a combination of three or more search terms may be selected as a co-occurring search term.

Next, a similarity parameter update process will be described with reference to FIG. 18. FIG. 18 is a flowchart of a similarity parameter update process according to the second embodiment. The similarity parameter update process is a process executed by the similarity parameter update unit 132 in step S43 of the estimation parameter update process.

(Step S121) The similarity parameter update unit 132 calculates a ratio of known ratios for each combination, of two known search terms. The ratio of known ratios is a value that is defined using the known ratios of two known search terms as parameters, and is represented by S_{i, j}. When xᵢ and xⱼ are two known search terms, rᵢ and rⱼ are the known ratios of the search terms xᵢ and xⱼ, then the ratio of known ratios S_{i, j} is represented by an expression (2)

S_{i, j}=max(rᵢ, rⱼ)/min(rᵢ, rⱼ) (2).

where max(rᵢ, rⱼ) is the grater one of the two known ratios, and min(rᵢ, rⱼ) is the smaller one of the two known ratios.

(Step S122) The similarity parameter update unit 132 calculates a known ratio difference for each combination of two known search terms. The known ratio difference is a value that is defined using the ratio of known ratios of two known search terms as a parameter, and is represented by d_{i, j}. The known ratio difference d_{i, j} is represented by an expression (3):

d_{i, j}=S_{i, j}/max(S) (3)

Where max(S) represents the greatest ratio among all the ratios of known ratios corresponding to all the combinations of known search terms.

(Step S123) The similarity parameter update unit 132 searches for, for each known search term, documents containing that known search term from the search result document set 19, and generates a neighboring word vector indicating a word (neighboring word) in the neighborhood of that known search term. The neighboring word vector is “1” when a neighboring word of the known search term xᵢ exists, and is “0” when the word does not exist. The neighboring word vector is represented by Aᵢ. When n types of words may be located in the neighborhood of the known search term (for example, within the sentence containing the known search term, or 5 words preceding and following the known search term), Aᵢ is an n-dimensional vector.

(Step S124) The similarity parameter update unit 132 sets a similarity parameter randomly. The similarity parameter is a vector in which the degree of importance of each term takes a value in the range from “0.0” to “1.0”, and is represented by W. That is, the similarity parameter update unit 132 randomly determines the value of each element of the vector W within the range from “0.0” to “1.0”. The number of dimensions of W is the same as the number of dimensions (n dimensions) of Aᵢ.

(Step S125) The similarity parameter update unit 132 determines whether the similarity parameter W satisfies a search condition. The search condition is an expression (4). That is the similarity parameter update unit 132 determines whether the expression (4) holds for any combination of known search terms (xᵢ, xⱼ). If the expression (4) does not hold for at least one combination of known search terms, the similarity parameter W is determined not to satisfy the search condition.

|AᵢW−AⱼW|≦d_{i, j} (4)

If the similarity parameter W satisfies the search condition, the process proceeds to step S128. If the similarity parameter W does not satisfy the search condition, the process proceeds to step S126.

(Step S126) The similarity parameter update unit 132 holds the similarity parameter W generated in step S124 as a candidate for update. Further, the similarity parameter update unit 132 calculates an evaluation value indicating the degree of divergence between the similarity parameter W and the search condition (for example, the sum of the difference between the left-hand side and the right-hand side of the expression (4) with respect to each combination of known search terms), and holds the evaluation value in association with the similarity parameter W.

(Step S127) The similarity parameter update unit 132 determines whether the number of trials in step S124 has reached the upper limit for example, 10,000 times). If the number of trials has reached the upper limit, the process proceeds to step S128. If the number of trials has not reached the upper limit, the process returns to step S124.

(Step S128) If in step S125 there is a similarity parameter W that satisfies the search condition, the similarity parameter update unit 132 updates the similarity parameter 17 with that similarity parameter W. On the other hand, if there is no similarity parameter W that satisfies the search condition, the similarity parameter update unit 132 updates the similarity parameter 17 with the similarity parameter W that is the most highly evaluated (for example, the similarity parameter W whose evaluation value indicating the degree of divergence is the smallest) among the similarity parameters W held in step S126. Then, the similarity parameter update process ends.

Note that the similarity parameter update unit 132 is able to serve as a global optimization apparatus that optimizes the degree of importance of neighbor words. The similarity parameter update unit 132 may provided as a global optimization apparatus independently of the search mediation server 10.

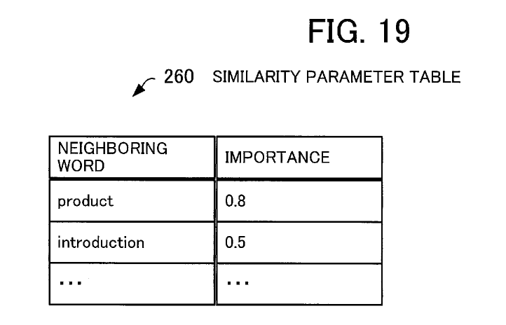

In the following, the data configuration of the similar parameter 17 will be described with reference to FIG. 19. FIG. 19 illustrates are example of a similarity parameter table 260 according to the second embodiment.

The similarity parameter table 260 is included in the similarity parameter 17. The similarity parameter table 250 includes the item “neighboring word” and the item “importance”. The item “neighboring word” indicates a neighboring word of a search term included in the search term set 14. The item “importance” indicates the degree of importance of the neighboring word, and corresponds to an element of the similarity parameter W. For example, the similarity parameter table 260 indicates that the degree of importance of a neighboring word “product” is “0.8”, and the degree of importance of a neighboring word “introduction” is “0.5”. In this case:, the neighboring word “product” has a high degree of importance than the neighboring word “introduction”. The degree of importance indicates the weight of a neighboring wore that is used for calculating the similarity between search terms. Generally, characteristic words such as nouns and verbs that are likely to co-occur with a specific search term tend to have a higher degree of importance. On the other hand, general words such as function words that are commonly used in documents tend to have a lower degree of importance.

Next, an estimated ratio update process will be described with reference to FIG. 20. FIG. 20 is a flowchart of an estimated ratio update process according to the second embodiment. The estimated ratio update process a process executed by the estimated ratio update unit 133 in step S44 of the estimation parameter update process.

(Step S131) The estimated ratio update unit 133 selects an unknown search term for which a known ratio is not set, from the search term set 14.

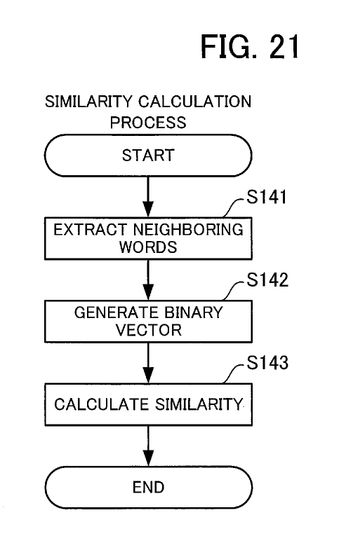

(Step S132) The estimated ratio update unit 133 executes a similarity calculation process. A similarity calculation process is a process that calculates the similarity between the selected unknown search term and a known search term, using the similarity parameter 17. The details of the similarity parameter calculation process will be described below with reference to FIG. 21.

(Step S133) The estimated ratio update unit 133 calculates the estimated ratio of the selected unknown search term based on the similarity. An estimated ratio gₖ of an unknown search term k is represented by an expression (5):

$${g}_{k} = \frac{{\sum }_{i = 1}^{N} {r}_{i} s ( k , i )}{{\sum }_{i = 1}^{N} s ( k , i )} \qquad ( 5 )$$

where rᵢ is the known ratio of a known search term i, s(k, i) is the similarity between the unknown search term k and the known search term i, and N is the number of known search terms.

For example, suppose that the known ratio of the search term “FFF” is “1,000”, and the known ratio of the search term “N station” is “900”. Then, when the similarity between the search term “BBB” and the search term “FFF” is “0.9” and the similarity between the search term “BBB” and the search term “N station” is “0.1”, the estimated ratio of the search term “BBB” is “990 (=1,000×0.9+900×0.1)”.

In this manner, the estimated ratio update unit 133 causes the known ratio of a known search term to strongly affect an unknown search term having a high similarity, and causes the known ratio of a known search term to slightly affect an unknown search term having a low similarity. Thus, the estimated ratio update unit 133 is able to accurately generate an estimated ratio from the known ratios.

(Step S134) The estimated ratio update unit 133 updates the ratio list 15 with the calculated estimated ratio. For example, when an estimated ratio “990” is calculated for the search term “BBB” which is an unknown search term, the estimated ratio update unit 133 records the estimated ratio in the ratio table 240 (see FIG. 15). At this point, the item “known ratio” for the search term “BBB” is “−” because the known ratio thereof is unknown.

(Step S135) The estimated ratio update unit 133 determines whether all the unknown search terms included in the search term set 14 have been selected. If -got all the unknown search terms included in the search term set 14 have been selected, the process returns to step S131. If all the unknown search terms included in the search term set 14 have been selected, the estimated ratio update process ends.

In this manner, the estimated ratio update unit 133 is able to update the ratio list 15 with the estimated ratios calculated for the unknown search terms included in the search term set 14.

Next, a similarity calculation process will be described with reference to FIG. 21. FIG. 21 is a flowchart of a similarity calculation process according to the second embodiment. The similarity calculation process is a process executed by the estimated ratio update unit 133 in step S132 of the estimated ratio update process.

(Step S141) The estimated ratio update unit 133 obtains documents containing the selected unknown search term from the sample document set 18, and extracts neighboring words that appear in the neighborhood of the selected unknown search term in the obtained documents. Further, the estimated ratio update unit 133 obtains, for each known search term, documents containing that known search term from the sample document set 18, and extracts neighboring words that appear in the neighborhood of that known search term in the obtained documents.

(Step S142) The estimated ratio update unit 133 generates a binary vector that indicates whether each word appears in the neighborhood of the selected unknown search term. Further, the estimated ratio update unit 133 generates, for each known search term, a binary vector that indicates whether each word appears in the neighborhood of that known search term. The binary vector generated herein has one or more elements corresponding to the neighboring words, and each element takes the valve “1” when the corresponding neighboring word exists, and takes the value “0” when the corresponding neighboring word does not exist.

Then, the estimated ratio update unit 133 multiplies each element of each of the binary vector corresponding to the unknown search term and the binary vectors corresponding to the respective known sea terms by the degree of importance included in the similarity parameter W corresponding to that element, and thereby generates a weighted vector. For example, in the case where the degree of importance of a neighboring word is “0.8”, the value of the clement corresponding to the neighboring word is “0.8” if the neighboring word exists, and is “0.0” if the neighboring word does not exist.

(Step S143) The estimated ratio update unit 133 calculates, for each known search term, the similarity between that known search term and the selected unknown search term, using the weighted vector co-responding to that known search term and the weighted vector corresponding to the select d unknown search term. The similarity may be calculated using a known calculation method such as cosine similarity. For example, a similarity s (p, q) is represented by an expression (6):

$$S ( p , q ) = \frac{{\sum }_{i = 1}^{N} {P}_{i}^{2} {q}_{i}^{2} }{{\sum }_{i = 1}^{N} {P}_{i}^{2} {{\sum }_{i = 1}}^{N} {q}_{i}^{2}} \qquad ( 6 )$$

where p is the weighted vector of an unknown search term, q is the weighted vector of a known search term, N is the number of elements of the weighted vector, pᵢ is the i-th element of the weighted vector p, and qᵢ is the i-th element of the weighted vector q.

After the estimated ratio update unit 133 calculates the similarity, the similarity calculation process ends.

Note that the similarity parameter update unit 132 is able to extract neighboring words by performing a morphological analysis. In this case, the similarity parameter update unit 132 is able to serve as a morphological analyzer. Note that the similarity parameter update unit 132 may delegate extraction of neighboring words to a morphological analyzer that is provided independently of the search mediation server 10.

Next, an estimated co-occurrence ratio update process will be described with reference to FIG. 22. FIG. 22 is a flowchart of an estimated co-occurrence ratio update process according to the second embodiment. The estimated co-occurrence ratio update process is a process executed by the estimated co-occurrence ratio update unit 134 in step S45 of the estimation parameter update process.

(Step S151) The estimated co-occurrence ratio update unit 134 obtains a set of co-occurring search terms (combinations of search terms) for which known co-occurrence ratios are set (a set-with-known-co-occurrence-ratios).

(Step S152) The estimated co-occurrence ratio update unit 134 obtains a set of co-occurring search terms for which known co-occurrence ratios are not set (a set-without-known-co-occurrence-ratios).

Step S153) The estimated co-occurrence ratio update unit 134 selects one co-occurring search term, from the set-without-known-co-occurrence-ratios.

(Step S154) The estimated co-occurrence ratio update unit 134, refers to a relationship dictionary, and obtains a set of relationships that the selected co-occurring search term may have.

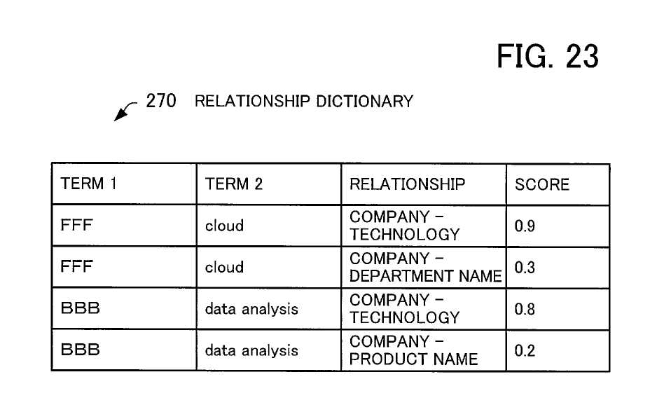

In the following, a relationship dictionary will be described with reference to FIG. 23. FIG. 23 illustrates an example of a relationship dictionary 270 according to the second embodiment.

The relationship dictionary 270 includes the item “term 1”, the item “term 2”, the item “relationship”, and the item “score”. The item “term 1” is one of search terms included in a combination. The item “term 2” is the other one of search terms included in the combination. The item “relationship” indicates the relationship between two search terms. The item “score” indicates the probability between two search terms. For example, the item “score” takes a value in the range from “0.0” to “1.0”. The closer to “1.0” the value is, the more the relationship between the two search terms is probable (the higher the probability of the term and the, term 2 being used to refer to the relationship indicated the item “relationship” is).

For example, a combination of the term 1 “FFF” and the term 2 “cloud” has a score “0.9” for relationship “company—technology”, and has a score “0.3” for the relationship “company—department name”. Thus, when the term 1 “FFF” and the term 2 “cloud” appear in the same document, the term 2 “cloud” may be used to refer to a technology, and may be used to refer to the name of a department. However, according to the relationship dictionary 270, the probability of the term 2 being used to refer to a technology is higher than that of being used to refer to the name of a department.

Further, a combination of the term 1 “BBB” and the term 2 “data analysis” has a score “0.8” for the relationship “company—technology”, and has a score of “0.2” for the relationship “company—product name”. Thus, when the term 1 “BBB” and the term 2 “data analysis” appear in the same document, the term 2 “data analysis” may be used to refer to a technology, and may be used to refer to the name of a product. However, according to the relationship dictionary 270, the probability of the term 2 being used to refer to a technology is higher than that of being used to refer to the name of a product.

By referring to this relationship dictionary 270, when a co-occurring search term “BBB & data analysis” is selected in step S153, for example, the estimated co-occurrence ratio update unit 134 is able to obtain relationship set including the relationship “company—technology” and the relationship “company—product name” as its elements.

(Step S155) The estimated co-occurrence ratio update unit 134 extracts, from the set-with-known-occurrence-ratios, a subset including co-occurring search terms each of which may have the relationship that is the same as any one of the relationships included in the relationship set (a subset-with-known-co-occurrence-ratios). For example, suppose that the co-occurring search term “BBB & data analysis” is selected in step S153, and the set-with-known-co-occurrence-ratios includes the co-occurring search term “FFF & cloud”. In this case, the co-occurring search term “FFF & cloud” may have the relationship “company—technology” that is included in the relationship set. Therefore, the co-occurring search term “FFF cloud” is included in the subset-with-known-co-occurrence-ratios.

(Step S156) The estimated co-occurrence ratio update unit 134 refers to the relationship dictionary, and calculates an estimated co-occurrence ratio for each of the relationships included in the relationship set. When r is a relationship included in a relationship set R; pᵢ is the known co-occurrence ratio of a co-occurring search term i included in a subset-with-known-co-occurrence-ratios; and sᵢ is the score corresponding to the co-occurring search term i and the relationship r in the relationship dictionary, if the relationship r is assumed, then an estimated co-occurrence ratio g_{k, r} of the co-occurring search term k is represented by an expression (7). Note that, in the case where the relationship r is not registered for the co-occurring search term i, the score sᵢ is “0”. Further, when the total of the scores sᵢ is “0”, the estimated co-occurrence ratio g_{k, r} is “0”.

For example, suppose that the co-occurring search term “BBB & data analysis” is selected in step S153, and the subset-with-known-co-occurrence-ratios includes only the co-occurring search term “FFF & cloud”. In this case, for the relationship “company—technology”, a known co-occurrence ratio “1,000”×score “0.9”/score “0.9”=an estimated co-occurrence ratio “1,000” is calculated for the relationship “company—product name”, since the co-occurring search term “FFF & cloud” does not have the relationship “company—product name”, an estimated co-occurrence ratio “0” is calculated.

$${g}_{k , r} = \frac{{\sum }_{i = 1}^{N} {p}_{i} {s}_{i}}{{\sum }_{i = 1}^{N} {s}_{i}} \qquad ( 7 )$$

(Step S157) The estimated co-occurrence ratio update unit 134 selects an estimated co-occurrence ratio q_{k, k} having the greatest value as a maximum estimated co-occurrence ratio, from among the calculated estimated co-occurrence ratios g_{k, r}. For example, if an estimated co-occurrence ratio “1,000” is calculated for the relationship “company—technology” and an estimated co-occurrence ratio “0” is calculated for the relationship “company—product name”, the estimated co-occurrence ratio update unit 134 selects the former as the maximum estimated co-occurrence ratio. This indicates that, in the case where the search term “BBB” and the search term data analysis appear in the same document, the estimated occurrence ratio update unit 134 assumes that there is a high probability of the ear terms being used to refer to the relationship “company—technology”, and causes the known co-occurrence ratio to affect the estimated co-occurrence ratio, based on this assumption.

(Step S158) The estimated co-occurrence ratio update unit 134 updates the co-occurrence ratio list 16 with the selected maximum estimated co-occurrence ratio. For example, when an estimated co-occurrence ratio “1,000” is calculated for the co-occurring search term “BBB & data analysis”, the estimated co-occurrence ratio update unit 134 records the estimated co-occurrence, ratio in the co-occurrence ratio table 250 (see FIG. 17). At this point, the item “know co-occurrence ratio” for the co-occurring search term “BBB & data analysis” is “−” because the known co-occurrence ratio thereof is unknown.

(Step S159) The estimated co-occurrence ratio update unit 134 determines whether all the co-occurring search terms included in the set-without-known-co-occurrence-ratios have been selected. If not all the co-occurring search terms included in the set-without-known-co-occurrence-ratios have been selected, the process returns to step S153. If all the co-occurring search terms eluded in the set-without-known-co-occurrence-ratios have been selected, the estimated co-occurrence ratio update process ends.

In this mangier, the estimated co occurrence ratio update unit 134 is able to update the co-occurrence ratio list 16 with the estimated co-occurrence ratios calculated for the combinations of search terms for which known co-occurrence ratios are not set.

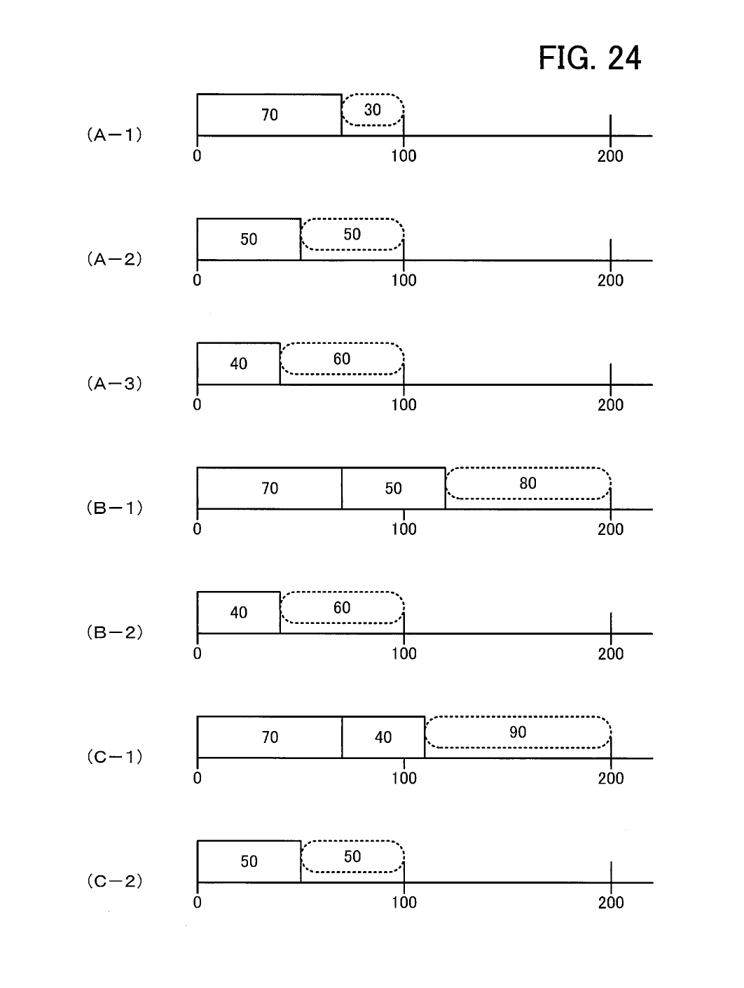

Next, the number of times a search query is issued in a reference embodiment and the number of times a search query is issued in the second embodiment will be described with reference to FIGS. 24 through 27. First, the number of times a search query is issued (in the case where sets of documents containing search terms do not overlap among a plurality of search terms in the reference embodiment will be described with reference to FIG. 24. FIG. 24 illustrates an example of issuing a search query (in the case where document sets do not overlap) according to the reference embodiment.

Suppose that the output limit number S of the document search server 52 is 100, and that a search term set 14 generated in response to a search request from the search terminal apparatus 51 includes a search term “A”, a search term “B”, and a search term “C”. The number of documents containing the search term “A” is “70”; the number of documents containing the search term “B” is “50”; the number of documents containing the search term “C” is “40”; and there is no overlapping document.

If the search mediation server 10 generates search queries without using the OR operator for the search terms “A”, “B”, and “C”, three search queries of a “query A”, a “query B”, and a “query C” are generated. The search mediation server 10 issues the “query A” to the document search server 52, and obtains “70” documents as the search results (A-1). Further, the search mediation server 10 issues the “query B” the document search server 52, and obtains “50” documents as the search results (A-2). Further, the search mediation server 10 issues the “query C” to the document search server 52, and obtains “40” documents as the search results (A-3). In this manner, the search mediation server 10 issues a search query three times to the document search server 52. In this case, the search mediation server 10 wastes the capacity to output “30” documents for the “query A” (A-1), wastes the capacity to output “50” documents for the “query B” (A-2), and wastes the capacity to output “60” documents for the “query C” (A-3), with respect to the output limit number S. The capacity to output documents that is wasted refers to the number of documents that may be obtained without issuing an additional query. That its this expression refers to the opportunities or resources for obtaining document that are wasted without obtaining documents.

Further, if the search mediation server 10 generates search queries while combining the search term “A” and the search term “B” with the OR operator, two search queries of a “query A OR B” and a “query C” are generated. The search mediation server 10 issues the “query A OR B” to the document search server 52, and obtains “120 (=70+50)” documents as the search results (B-1). However, since, the number of documents “120” exceeds the output limit number S, the search mediation server 10 obtains the documents in two batches, more specifically, “100” documents in the first batch an “20” documents in the second batch. Accordingly, the search mediation server 10 issues the “query A OR B” twice, and obtains “120” documents as the search results. Further, the search mediation server 10 issues the “query C” to the document search server 52, and obtains “40” documents as the search results (B-2). In this manner, the search mediation server 10 issues a search query three times to the document search server 52. In this case, with respect to the output limit number S, the search mediation server 10 wastes the capacity to output “80” documents for the “query A OR B” (B-1), and wastes the capacity to output “60” documents for the “query C” (B-2).

Further, if the search mediation server 10 generates search queries while combining the search term “A” and the search term “C” with the OR operator, two search queries of a “query A OR C” and a “query B” are generated. The search mediation server 10 issues the “query A OR C” to the document search server 52, and obtains “110 (=70+40)” documents as the search results (C-1). However, since the number of documents “110” exceeds the output limit number S, the search mediation server 10 obtains the documents in two batches, more specifically, “100” documents in the first batch and “10” documents in the second batch. Accordingly, the search mediation server 10 issues the “query A OR C” twice, and obtains “110” documents as the, search results. Further, the search mediation server 10 issues the “query B” to the document search server 52, and obtains “50” documents as the search results (C-2). In this manner, the search mediation server 10 issues a search query three times to the document search server 52, in this case, with respect to the output limit number S, the search mediation server 10 wastes the capacity to output “90” documents for the “query A OR C” (C-1), and wastes the capacity to output “50” documents for the “query B” (C-2).

Thus, in the case where an appropriate combination of search terms is not selected, a query generated using the OR operator does not contribute to reducing the number of times a search query is issued.

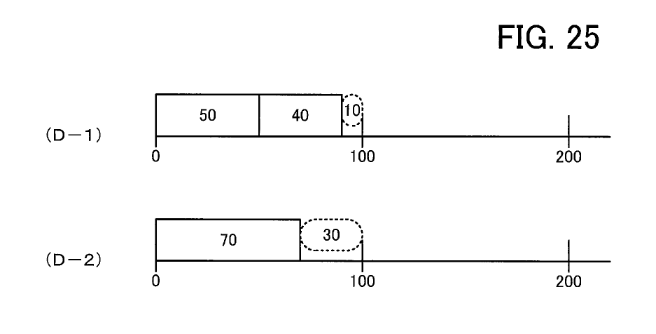

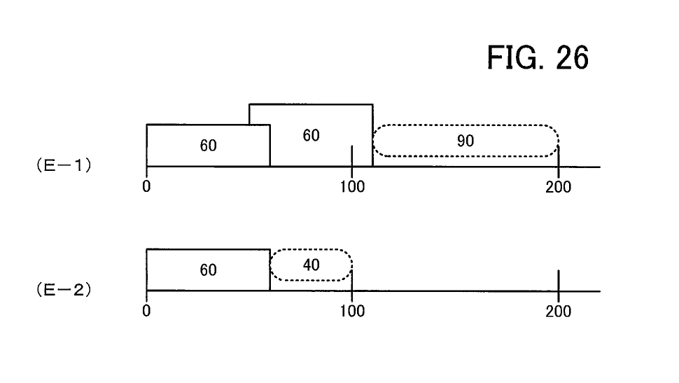

Next, the number of times a search query is issued (in the case where document sets do not overlap) in the second embodiment will be described with reference to FIG. 25. FIG. 25 illustrates an example of issuing a search query (in the case where document sets do not overlap) according to the second embodiment.

If the search mediation server 10 generates search queries while combining the search term “B” and the search term “C” with the OR operator, two search queries of a “query B OR C” and a “query A” are generated. The search mediation server 10 issues the “query B OR C” to the document search server 52, and obtains “90 (=50+40)” documents as the search results (D-1). Further, the search mediation server 10 issues the “query A” to the document search server 52, and obtains “70” documents as the search results (D-2). In this manner, the search mediation server 10 issues a search query twice to the document search server 52. In this case, with respect to the output limit number S, the search mediation server 10 wastes the capacity to output “10” documents for the “query B OR C” (D-1), and wastes the capacity to output “30” documents for the “query A” (D-2).

Thus, by selecting an appropriate combination of search terms, the search mediation server 10 is able to reduce the number of times a search query is issued. Such an appropriate combination of search terms selected by the query construction unit 11. Further, the accuracy of the query construction unit 11 in selecting a combination of search terms is improved by the estimation parameter update unit 13.

Next, the number of times a search query is issued (in the case where sets of documents containing search terms overlap among a plurality of search terms) in the reference embodiment will be described with reference to FIG. 26. FIG. 26 illustrates an example of issuing a search query (in the case where document sets overlap) according to the reference embodiment.

Note that the number of documents containing the search term “A” is “60”; the number of documents containing the search term “B” is “60”; the number of documents containing the search term “C” is “60”; and there are overlapping documents. There are “10” overlapping documents between the search term “A” and the search term “B”; there are “20” overlapping documents between the search term “A” and the search term “C”; and there are “20” overlapping documents between the search term “B” and the search term “C”.

If the search mediation server 10 generates search queries while combining the search term “A” and the search term “B” with the OR operator, two search queries of a “query A OR B” and a “query C” are generated. The search mediation server 10 issues the “query A OR F” to the document search server 52, and obtains “110 (=60+60−10)” documents as the search results (E-1). However, since the number of documents “110” exceeds the output limit number S, the search mediation server 10 obtains the documents in two batches, more specifically, “100” documents in the first batch and “10” documents in the second batch. Accordingly, the search mediation server 10 issues the “query A OR B” twice, and obtains “110” documents as the search results. Further, the search mediation server 10 issues the “query C” to the document search server 52, and obtains “60” documents as the search results (E-2). In this manner, the search mediation server 10 issues a search query three times to the document search server. In this case, with respect to the output limit number S, the search mediation server 10 wastes the capacity to output “90” documents for the “query A OR B” (E-1), and wastes the capacity to output “40” documents for the “query C” (E-2).

Thus, in the case where document sets overlap as well, if an appropriate combination of search terms is not selected, a query generated using the OR operator does not contribute to reducing the number of times a search query is issued.

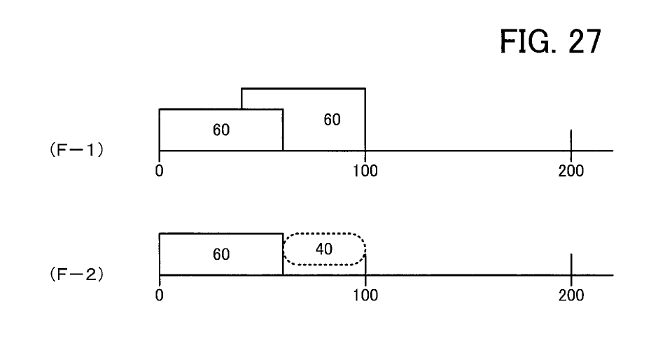

Next, the number of times a search query is issued (in the case where document sets overlap) in the second embodiment will be described with reference to FIG. 27. FIG. 27 illustrates an example of issuing a search query (in the case where document sets overlap) according to the second embodiment.

If the search mediation server 10 generates search queries while combining the search term “A” and the search term “C” with the OR operator, two search queries of a “query A OR C” and a “query B” are generated. The search mediation server 10 issues the “query A OR C” to the document search server and obtains “100 (=60+60−20)” documents the search results (F-1). Further, the search mediation server 10 issues the “query B” to the document search server 52, and obtains “60” documents as the search results (F-2). In this manner, the search mediation server 10 issues a search query twice to the document search server 52. In this case, with respect to the output limit number S, the search mediation server 10 does not waste the capacity to output documents for the “query A OR C” (F-1), and wastes the capacity to output “40” documents for the “query B” (F-2).

Thus, in the case where document sets overlap as well by selecting an appropriate combination of search terms, the search mediation server 10 is able to reduce the number of time a search query issued. Such an appropriate combination of search terms is selected by the query construction unit 11. Further, the accuracy of the query construction unit 11 in selecting a combination of search terms is improved by the estimation parameter update unit 13.

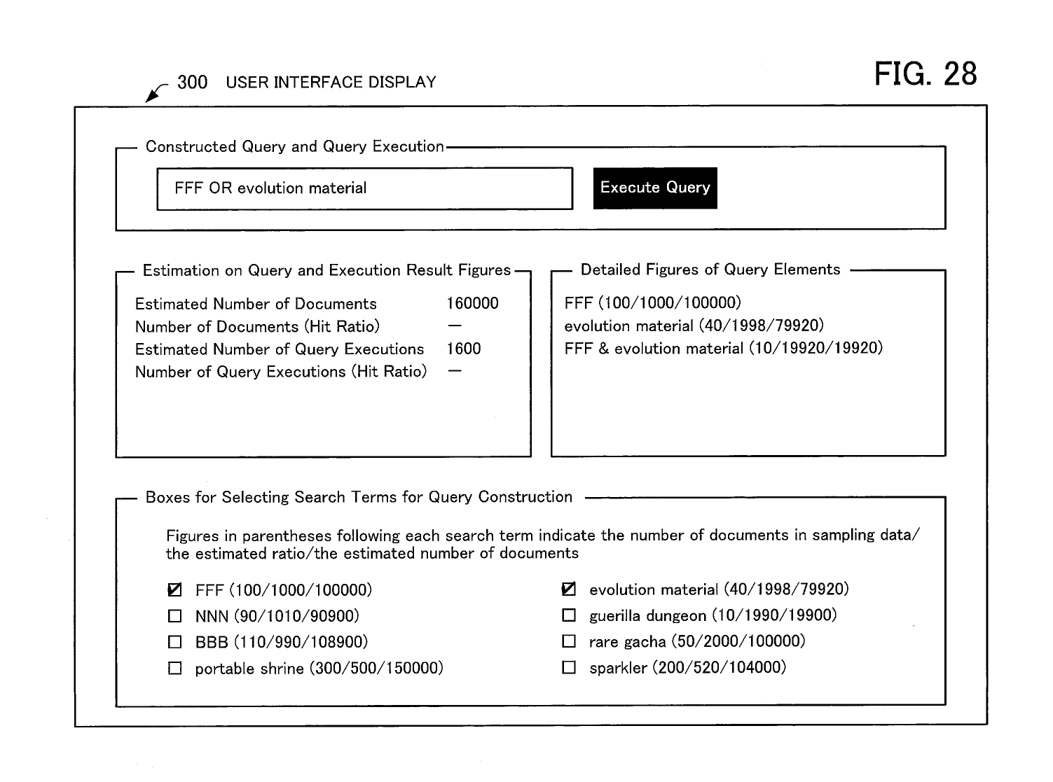

Next, user interface displays in the second embodiment will be described with reference to FIGS. 28 through 30. First, a use interface display before query execution will be described with reference to FIG. 28. FIG. 28 illustrates an example a user interface display 300 before query execution according to the second embodiment.

The user interface (UI) display 300 is a display for receiving an operation of executing a search query. The search terminal apparatus 51 acquires needed information from the search mediation server 10, and displays the user interface display 300 on a display of the search terminal apparatus 51.

The user interface display 300 indicates that a search time “FFF” and a search term “evolution material” are selected, and that a search query “FFF OR evolution material” is constructed. Further, the user interface display 300 indicates that, with respect to the search query “FFF OR evolution material”, 160,000 documents are expected to be obtained as the search results, and that the search query is expected to be executed 1,600 times to obtain the documents.

The user interface display 300 includes the display field “constructed query and query execution”, the display field “estimation on query and execution result figures”, the display field “detailed figures of query elements”, and the display field “boxes for selecting search terms for query construction”.

The display field “boxes for selecting search terms for query construction.” includes a list of selectable search terms, and also indicates, for each search term, the number of documents containing the search term among the sampling data (the sample document set 18), the estimated ratio, the estimated number of documents, and a check box for receiving an operation of selecting the search term. If the check box is checked, it indicates that the corresponding search term is selected.

The display field “estimation on query and execution result figures” includes the display item “estimated number of documents”, the display item “number documents (hit ratio)”, the display item “estimated number of query executions”, and the display item “number of query executions (hit ratio)”. The display item “estimated number of documents” indicates the number of documents expected to be obtained as the search results of the constructed query. The display item “number of documents (hit ratio)” indicates the number of documents actually obtained as the search results of the constructed query (search query), and also indicates the hit ratio to the estimated number of documents (the hit ratio of the number of obtained documents) in parentheses. The display item “estimated number of query executions” indicates the number of times the constructed query is expected to be executed to obtain the search results. The display item “number of query executions (hit ratio)” indicates the number of times the constructed query is actually executed to obtain the search results, and also indicates the hit ratio to the estimated number of query executions (the hit ratio of the number of query executions) in parentheses. Note that since the user interface display 300 displays the status at the time when the constructed query is not yet executed, “−” is displayed in each of the display item “number of documents (hit ratio)” and the display item “number of query executions (hit ratio)”.

The display field “detailed figures of query elements” indicates the selected search terms, and also indicates, for each selected search term, the number of documents containing the search term among the sampling data, the estimated ratio, and the estimated number of documents. Further, the display field “detailed figures of query elements” indicates, for a combination of the selected search terms, the number of documents containing the combination, the estimated ratio, and the estimated number of documents.

The display field “constructed query and query execution” displays the item “constructed query” and the operation button “execute query”. The item “constructed query” displays the constructed search query including the selected search terms. The operation button. “execute query” allows the user to execute the search query.

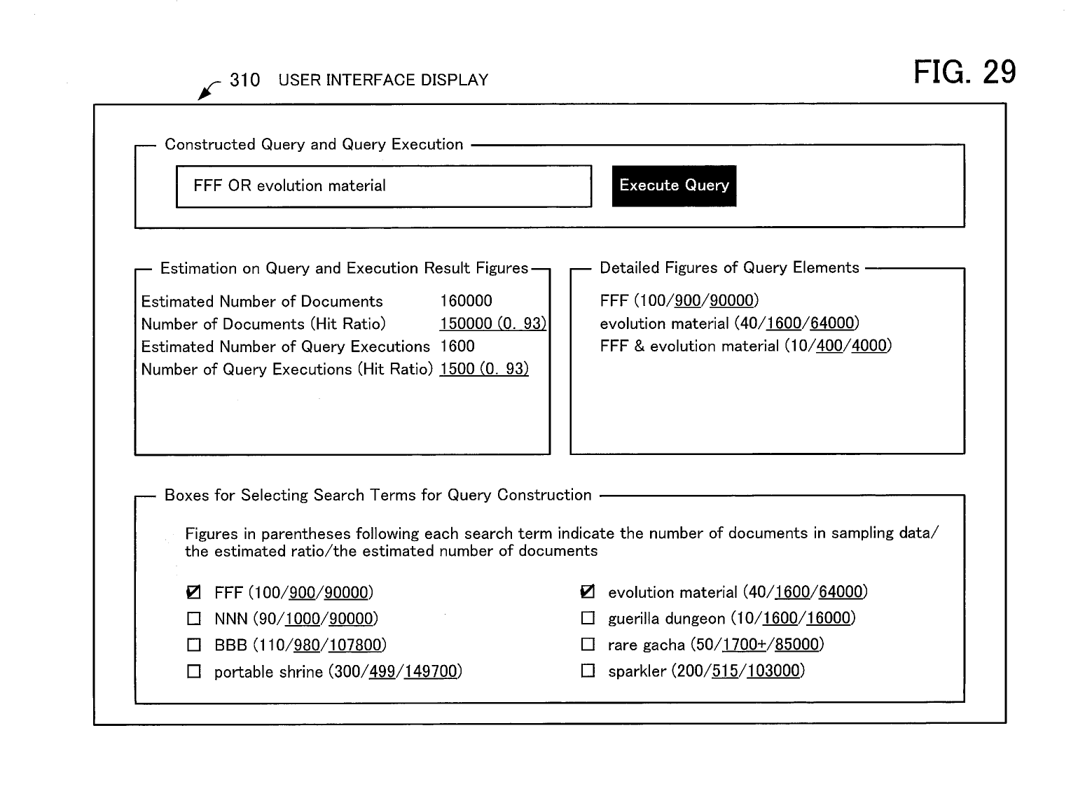

Next, a user interface display after query execution will be described with reference to FIG. 29. FIG. 29 illustrates an example of a user interface display 310 after query execution according to the second embodiment.

The user interface display 310 is a display after a search query is executed by the user. The search terminal apparatus 51 acquires needed information including the search results from the search mediation server 10, and displays the user interface display 310 on the display of the search terminal apparatus 51.

The user interface display 310 indicates that, with respect to the search query “FFF OR evolution material”, while 160,000 documents are expected to be obtained as the search results, 150,000 documents are actually obtained as the search results. The user interface display 310 indicates that the hit ratio of the number of obtained documents is “0.93 (=150,000/160,000)”. The user interface display 310 indicates that, with respect to the search query “FFF OR evolution material”, while the search query is expected to be executed 1,600 times, the search query is actually executed 1,500 times. The user interface display 310 indicates that the hit ratio of the number of query executions is “0.93 (=1,500/1,600)”.

Further, the user interface display 310 displays, for each search term, the updated estimated ratio and the updated estimated number of documents, based on the parameters that are updated in accordance with the search results (in FIG. 29, updated figures are underlined).

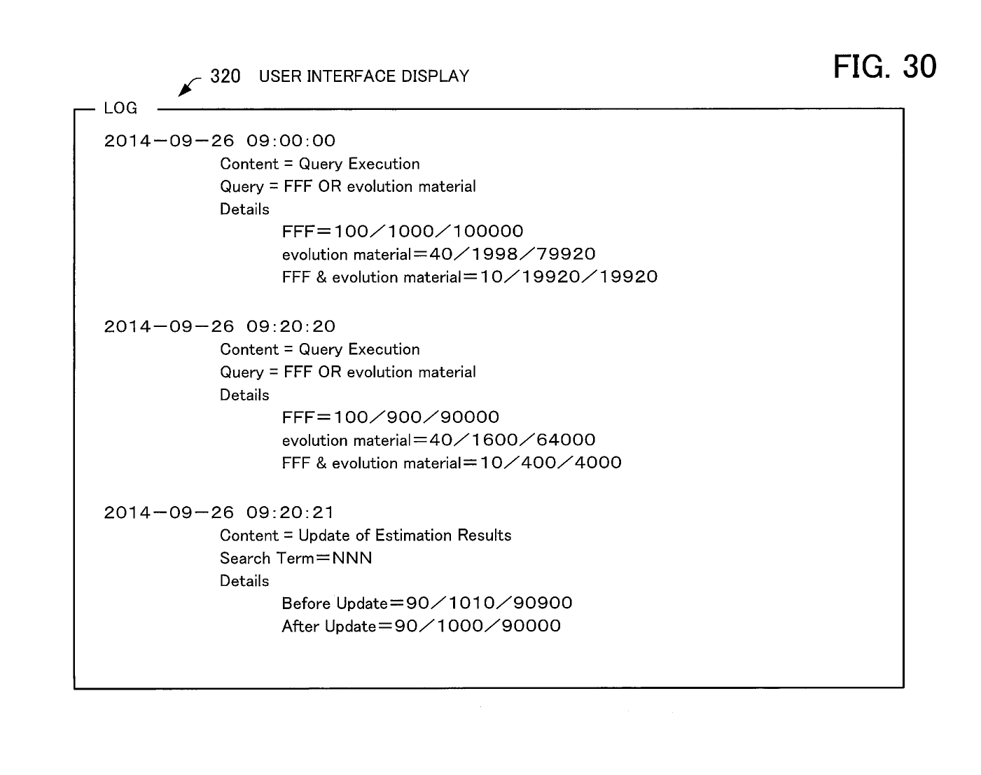

Next, a log display after query execution will be described with reference to FIG. 30. FIG. 30 illustrates an example of a use interface display 320 displaying a log according to the second embodiment.

The user interface display 320 displays a log display after query execution. The search terminal apparatus 51 acquires needed information from the search mediation server 10, and displays the user interface display 320 on the display of the search terminal apparatus 51.

The user interface display 320 displays three log as a part of or the logs. Each log includes the time when an event occurred and the content of the event. For example, the log of an event occurred at “2014-09-26 09:00:00” indicates that the content is “query execution” and the query (search query) is “FFF OR evolution material”. Further, the log of the event occurred at “2014-09-26 09;00:00” includes detailed figures of the query elements as detailed information.

The log of an event occurred at “2014-09-26 09:20:21” indicates that the content “update of estimated results” and the search term is “NNN”. Further, the log of the event occurred “2014-09-26 09:20:21” includes detailed figures of the search term before and after the update.

Such a user interface display assists the user to generate a search request, and contributes to improving the search efficiency.

Note that, in the above description, the user interface is displayed by the search terminal apparatus 51. However, according to a modified embodiment, the user interface may be displayed on a display of the search mediation server 10. In this case, if the search mediation server 10 includes a function as a search terminal apparatus, the search mediation server 10 may display the interface for the user who is performing a search. Further, if the search mediation server 10 does not include a function as a search terminal apparatus, the search mediation server 10 may display the interface for the administrator.

The above-described processing functions may be implemented by a computer. In this case, program describing to operations of the functions of the document search apparatus 1 or the search mediation server 10 is provided. When the program is executed by a computer, the above-described processing functions are implemented on the computer. The program describing operations of the functions may be stored in a computer-readable storage medium. Examples of computer-readable storage media include magnetic storage devices, optical discs, magneto-optical storage media, semiconductor memory devices, and the like. Examples of magnetic storage devices include, hard disk drive, (HDD), flexible disk (FD), magnetic tapes, and the like. Examples of optical discs include digital versatile disk (DVD), DVD-RAM, CD-RW, and the like. Examples of magnet-optical storage media include magneto-optical disk (MO) and the like.

For distributing the program, the program may be stored and sold in the form of a portable storage medium such as DVD, CD-ROM, and the like, for example. The program may also be stored storage device of a server computer, and transmitted from the server computer to other computers via a network.

For executing the program on a computer, the computer stores the program recorded in the portable storage medium or the program transmitted from the server computer in its storage device. Then, the computer reads the program from its storage device and performs processing in accordance with the program. The computer may read the program directly from the portable recording medium, and execute processing in accordance with the program. Further, the computer may sequentially receive the program from a server computer connected over a network, and perform processing in accordance with the received program.

The above-described processing functions may also be implemented wholly or partly by using electronic circuits such as DSP, ASIC, PLD, and the like.

According to one aspect, a document search apparatus, a document search method, and a document search program are capable of reducing the number of times that a search query is issued under system restrictions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope, of the invention.

What is claimed is:

1. A document search apparatus comprising:
a memory configured to store a plurality of search terms specified by a request, the request requesting a search for a document containing at least one of the plurality of search terms by using a system that manages a document set; and
a processor configured to perform a procedure including;
when selecting two or more search terms from the plurality of search terms and generating a search query that includes the selected two or more search terms and that is to be input to the system, determining a combination of search terms to be selected such that a size of the search query is equal to or less than a first threshold, and such that an estimated value of a number of documents to be retrieved by the system in response, to the search query is equal to or less than a second threshold.

2. The document search apparatus according to claim 1, wherein the procedure further includes evaluating each of candidate combinations of search terms obtained from the plurality of search terms, based on a difference between the estimated value and the second threshold.

3. The document search apparatus according to claim 1, wherein the procedure further includes:
calculating first multiplication factor corresponding to a first search term and a second multiplication factor corresponding to a second search term, for a relationship in a number of documents between another document set and the document set; and
when the first search term and the second search term are included in any of the candidate combinations of search terms, calculating the estimated value using a number of first documents containing the first search term among the other document set, a number of second documents containing the second search term among the other document set, the first multiplication factor, and the second multiplication factor.

4. The document search apparatus according to claim 3, wherein the procedure further includes, when the first multiplication factor is known and the second multiplication factor is unknown, estimating the second multiplication factor, based on an appearance status of the first search term in the other document set, an appearance status of the second search term in the other document set, and the first multiplication factor.

5. The document search apparatus according to claim wherein:
the procedure further includes calculating a third multiplication factor corresponding to a combination of the first search term and the second search term, for the relationship in the number of documents between the other document set and the document set; and
the calculating the estimated value includes calculating the estimated value using a number of third documents containing both the first search term and the second search term among the other document set, and the third multiplication factor, in addition to the number of first documents, the number of second documents, the first multiplication factor, and the second multiplication factor.

6. The document search apparatus according to claim 3, wherein the procedure further includes:
updating the first multiplication factor and the second multiplication factor, based on search results obtained from the system in response to the search query; and
generating another search query by selecting other two or more search terms from the plurality of search terms, based on the updated first multiplication factor and the updated second multiplication factor.

7. A document search method comprising
obtaining, by a processor, a request specifying a plurality of search terms, the request requesting a search for a document containing at least one of the plurality of search terms by using a system that manages a document set; and
selecting, by the processor, two or more search terms from the plurality of search terms specified by the request, and generating a search query that includes the selected two or more search terms and that is to be input to the system;
wherein the selecting includes determining a combination of search terms to be selected such that a size of the search query is equal to or less than a first threshold, and such that an estimated value of a number of documents to be retrieved by the system in response to the search query is equal to or less than a second threshold.

8. A non-transitory computer-readable storage medium storing a computer program that causes a computer to perform a procedure for searching for a document, the procedure comprising
obtaining a request specifying a plurality of search terms, the request requesting a search for a document containing at least one of the plurality of search terms by using a system that manages a document set; and
selecting two or more search terms from the plurality of search terms specified by the request, and generating a search query that includes the selected two or more search terms and that is to be input to the system;
wherein the selecting includes determining a combination of search terms to be selected such that a size of the search query is equal to or less than a first threshold, and such that an estimated value of a number of documents to be retrieved by the system in response to the search query is equal to or less than a second threshold.
